(19) United States
(12) Patent Application Publication
(10) Pub. No.: US 2024/0155672 A1
(43) Pub. Date: May 9, 2024

(54) SIDELINK RESOURCE POOL CONFIGURATIONS INCLUDING SIDELINK SYNCHRONIZATION SIGNAL BLOCK SLOTS

(71) Applicant: QUALCOMM Incorporated, San Diego, CA (US)

(72) Inventors: Jae Ho RYU, San Diego, CA (US); Chih-Hao LIU, San Diego, CA (US); Hari SANKAR, San Diego, CA (US)

(21) Appl. No.: 18/052,539

(22) Filed: Nov. 3, 2022

(51) Int. Cl. H04W 74/08

(52) U.S. Cl. CPC H04W 74/0808

(57) ABSTRACT

Wireless communications systems, apparatuses, and methods are provided. A method of wireless communication performed by a first sidelink user equipment (UE) may include transmitting a sidelink synchronization signal block (S-SSB) in a first S-SSB slot of an S-SSB burst, and communicating a sidelink communication in at least one remaining S-SSB slot of the S-SSB burst.

### TECHNICAL FIELD

This application relates to wireless communications, and more particularly, to sidelink resource pool configurations including sidelink synchronization signal block (S-SSB) slots for sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### Brief Summary of Some Examples

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include transmitting a sidelink synchronization signal block (S-SSB) in a first S-SSB slot of an S-SSB burst, and communicating a sidelink communication in at least one remaining S-SSB slot of the S-SSB burst. Associated devices, systems, means, and/or non-transitory computer readable media having one or more instructions for execution by one or more processors of a first sidelink UE are also provided.

In an additional aspect of the disclosure, a method of wireless communication performed by a sidelink user equipment (UE) may include receiving, from another sidelink UE, a sidelink synchronization signal block (S-SSB) in a first S-SSB slot of an S-SSB burst, and communicating, based on the receiving the S-SSB, a sidelink communication in at least one remaining S-SSB slot of the S-SSB burst. Associated devices, systems, means, and/or non-transitory computer readable media having one or more instructions for execution by one or more processors of a sidelink UE are also provided.

In an additional aspect of the disclosure, a first sidelink user equipment (UE) may include a memory; a transceiver; and at least one processor coupled to the memory and the transceiver, wherein the first sidelink UE is configured to transmit a sidelink synchronization signal block (S-SSB) in a first S-SSB slot of an S-SSB burst, and communicate a sidelink communication in at least one remaining S-SSB slot of the S-SSB burst.

In an additional aspect of the disclosure, a sidelink user equipment (UE) may include a memory; a transceiver; and at least one processor coupled to the memory and the transceiver, wherein the sidelink UE is configured to receive, from another sidelink UE, a sidelink synchronization signal block (S-SSB) in a first S-SSB slot of an S-SSB burst, and communicate, based on the receiving the S-SSB, a sidelink communication in at least one remaining S-SSB slot of the S-SSB burst.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates a sidelink wireless communication network according to some aspects of the present disclosure.

FIG. 3 illustrates synchronization sources for a sidelink wireless communication network according to some aspects of the present disclosure.

FIG. 4 illustrates an example of a frame format according to some aspects of the present disclosure.

FIG. 5 illustrates an example of a resource configuration that supports S-SSB bursts according to some aspects of the present disclosure.

FIG. 6 illustrates an example of a resource configuration that supports sidelink resource pool configuration to include one or more S-SSB blocks in an S-SSB burst according to some aspects of the present disclosure.

FIG. 7 illustrates an example of a resource configuration that supports sidelink resource pool configuration to include one or more S-SSB blocks in an S-SSB burst according to some aspects of the present disclosure.

FIG. 8 illustrates an example of a resource configuration that supports sidelink resource pool configuration to include one or more S-SSB blocks in an S-SSB burst according to some aspects of the present disclosure.

FIG. 9 is a signaling diagram of a wireless communication method according to some aspects of the present disclosure.

FIG. 10 is a signaling diagram of a wireless communication method according to some aspects of the present disclosure.

FIG. 11 is a signaling diagram of a wireless communication method according to some aspects of the present disclosure.

FIG. 12 is a block diagram of an exemplary user equipment (UE) according to some aspects of the present disclosure.

FIG. 13 is a block diagram of an exemplary network unit according to some aspects of the present disclosure.

FIG. 14 is a flow diagram of a communication method according to some aspects of the present disclosure.

FIG. 15 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. In some implementations, the SCI in the PSCCH may referred to as SCI part 1 (SCI-1), and additional SCI, which may be referred to as SCI part 2 (SCI-2) may be carried in the PSSCH. The SCI-2 can include control information (e.g., transmission parameters, modulation coding scheme (MCS)) that are more specific to the data carrier in the PSSCH. Use cases for sidelink communication may include V2X, enhanced mobile broadband (eMBB), industrial IoT (IIoT), NR-lite, and/or NR-super-lite. NR-lite may refer to a reduced-version of NR in terms of UE power consumptions, capabilities, and/or cost. NR-super-lite may refer to a further reduced-version of NR in terms of UE power consumptions, capabilities, and/or cost.

As used herein, the term “sidelink UE” can refer to a user equipment device performing a device-to-device communication or other types of communications with another user equipment device independent of any tunneling through the BS (e.g., gNB) and/or an associated core network. As used herein, the term “transmitting sidelink UE” can refer to a user equipment device performing a sidelink transmission operation. As used herein, the term “receiving sidelink UE” can refer to a user equipment device performing a sidelink reception operation. As used herein, the terms “sync UE”, “SyncRef UE”, “sidelink sync UE”, “anchor UE”, or “sidelink anchor UE” refer to a sidelink UE transmitting a sidelink-synchronization signal block (S-SSB) to facilitate sidelink communications among multiple sidelink UEs (e.g., when operating in a standalone sidelink system), and the terms are interchangeable without departing from the scope of the present disclosure. As used herein, the terms “non-sync UE”, “non-SyncRef UE”, or “sidelink non-sync UE” refer to a sidelink UE yet to complete a synchronization process based on receiving an S-SSB. A sidelink UE may operate as a transmitting sidelink UE at one time and as a receiving sidelink UE at another time. A sidelink sync UE or a sidelink non-sync UE may also operate as a transmitting sidelink UE at one time and operate as a receiving sidelink UE at another time.

NR supports two modes of radio resource allocations (RRA), a mode-1 RRA and a mode-2 RRA, for sidelink communications. The mode-1 RRA supports network controlled RRA that can be used for in-coverage sidelink communication. For instance, a serving BS (e.g., gNB) may determine a radio resource on behalf of a sidelink UE and transmit an indication of the radio resource to the sidelink UE. In some aspects, the serving BS grants a sidelink transmission with downlink control information (DCI). For this mode, however, there is significant base station involvement and is only operable when the sidelink UE is within the coverage area of the serving BS. The mode-2 RRA supports autonomous RRA that can be used for out-of-coverage sidelink UEs or partial-coverage sidelink UEs. For instance, a serving BS may configure a sidelink UE (e.g., while in coverage of the serving BS) with sidelink resource pools which may be used for sidelink when the sidelink UE is out of the coverage of the serving BS. A serving BS may also configure a sidelink UE to operate as a sidelink anchor UE to provide sidelink system information for out-of-coverage sidelink UEs to communicate sidelink communications. Thus, a sidelink anchor UE may operate as a mini-gNB facilitating and/or coordinating communications among sidelink UEs over. A sidelink channel where two UEs may communicate with each other directly may also be referred to as a PC5 interface.

Some sidelink systems may operate over a 20 MHz bandwidth in an unlicensed band. ABS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. In some aspects, a sidelink resource pool may include a set of sidelink resources (e.g., time-frequency resources). Each sidelink resource may include a PSCCH and a PSSCH. In some aspects, a sidelink UE may support half-duplex communications. In other words, the sidelink UE may perform transmission or reception at any given time, but not both transmission and reception at the same time. Thus, the total amount of resources in a sidelink resource pool is shared between transmission and reception. A transmitting sidelink UE may transmit a sidelink transmission using one of the sidelink resources from the sidelink resource pool. The sidelink transmission may include SCI (in a PSCCH of a sidelink resource) and sidelink data (in a PSSCH of the sidelink resource). The SCI may indicate control information, such as a destination identifier (ID) identifying a receiving sidelink UE for the sidelink data transmission being transmitted, and/or a reservation for a future sidelink resource. Thus, a receiving sidelink UE or monitoring UE may perform SCI sensing or monitoring in the sidelink resource pool to determine whether there is data addressed to the receiving sidelink UE or not. If the receiving sidelink UE detected SCI (in a PSCCH of a sidelink resource) including a destination ID identifying the receiving sidelink UE, the receiving sidelink UE may proceed to receive corresponding sidelink data (in a PSSCH of the sidelink resource). In some aspects, a sidelink UE may continuously monitor for SCI in the sidelink resource pool to determine whether there is data for the receiving sidelink UE or a reservation for a future sidelink resource whenever the sidelink UE is not performing a sidelink transmission.

A sidelink sync UE may provide sidelink system information by broadcasting S-SSB(s). The S-SSB may be analogous to the SSB broadcast by a BS. For instance, an S-SSB may include synchronization signals and/or sidelink system information. Some examples of sidelink system information may include a sidelink bandwidth part (BWP) configuration, S-SSB transmission related parameters (e.g., sidelink slots configured for S-SSB transmission and/or S-SSB transmission periodicity), and/or any other configuration information related to sidelink communications.

In certain aspects, multiple S-SSBs may be transmitted in a burst where S-SSBs are transmitted in a number of contiguous slots associated with the S-SSB burst. The slots configured for S-SSB burst are referred to as S-SSB slots. The S-SSB burst may be periodically repeated, and so are the S-SSB slots. One issue with sidelink communications is that once slots are reserved as S-SSB slots, they cannot be included in the sidelink resource pool for PSCCH/PSSCH transmission. A transmitting sidelink UE may have to wait until the S-SSB burst finishes to attempt PSCCH/PSSCH transmission, and a receiving sidelink UE may have to wait until the S-SSB burst finishes to perform SCI sensing to determine whether there is data addressed to the receiving sidelink UE or not. As such, spectral efficiency in sidelink communications is not optimized.

The present application describes mechanisms for sidelink resource pool configurations that include S-SSB slots for PSCCH/PSSCH transmission to increase spectral efficiency, enable more efficient use of network resources, and/or enable a more cost-effective and/or energy efficient network deployment. In certain aspects, a first sidelink UE (e.g., a sidelink sync UE) may transmit a sidelink resource pool configuration to a second sidelink UE (e.g., a sidelink non-sync UE) via a PC5 communication, sidelink control information (e.g., SCI-1, SCI-2), a radio resource control (RRC) communication, or other suitable communication. The sidelink resource pool configuration may indicate whether S-SSB slots are included in sidelink resource pool, such as by including a one-bit flag Sidelink-SSB-Slots-Included. For example, the flag being “1” may indicate S-SSB slots are included in sidelink resource pool, and sidelink UEs may select a sidelink resource including S-SSB slots from sidelink resource pool, while the flag being “0” may indicate S-SSB slots are excluded from sidelink resource pool, and sidelink UEs may select a sidelink resource from sidelink resource pool after excluding S-SSB slots. Additionally or alternatively, the first sidelink UE and/or the second sidelink UE may receive the sidelink resource pool configuration from a network unit via downlink control information (DCI), a radio resource control (RRC) communication, or other suitable communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

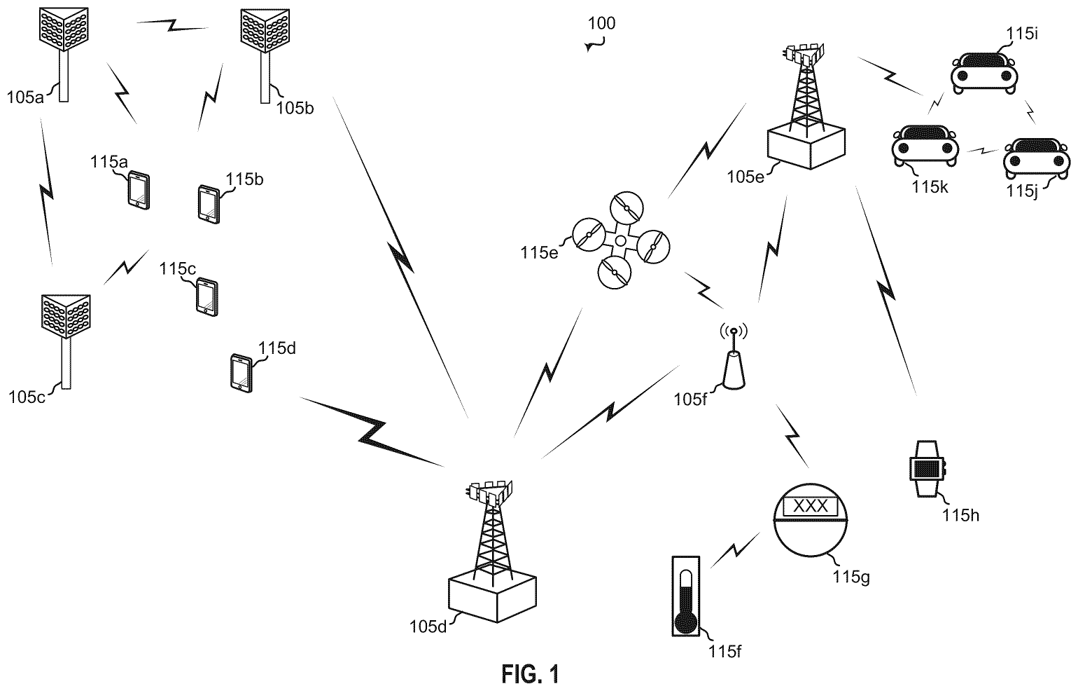

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V21) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

In some aspects, a BS 105 may transmit a sidelink resource pool configuration, such as part of an RRC configuration, to a first sidelink UE 115 indicating that S-SSB slots in an S-SSB burst being included in sidelink resource pool. Such an indication may be implemented as a one-bit flag in the RRC configuration. The first sidelink UE 115 may further transmit the configuration to a second sidelink UE 115 indicating that S-SSB slots in an S-SSB burst being included in sidelink resource pool. In some aspects, the first sidelink UE 115 may transmit an S-SSB to the second sidelink UE 115 and further select a sidelink resource including one or more remaining S-SSB slots in the S-SSB burst for PSCCH/PSSCH transmission. The second sidelink UE 115 may receive the S-SSB transmitted from the first sidelink UE 115 and further perform PSCCH monitoring in the remaining S-SSB slots in the S-SSB burst for PSCCH/PSSCH reception.

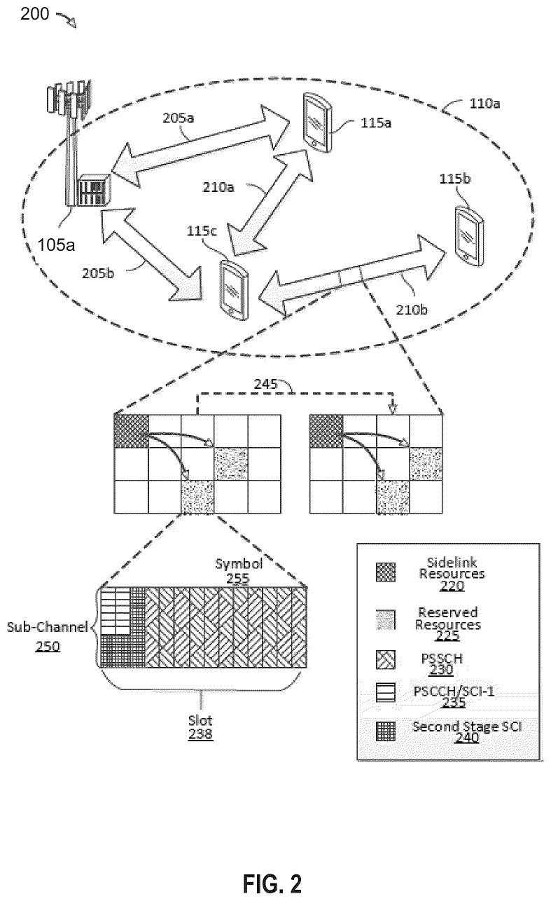

FIG. 2 illustrates sidelink resources associated with a wireless communication network 200 according to some aspects of the present disclosure. The wireless communications network 200 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 205a and 205b, respectively. UE 115c may communicate with UEs 115a and 115b via sidelink communication links 210a and 210b, respectively. In some examples, UE 115c may transmit SCI to UEs 115a and 115b via the sidelink control resources 220. The SCI may include an indication of resources reserved for retransmissions by UE 115c (e.g., the reserved resources 225).

In some aspects, a device in the wireless communication network 200 (e.g., a UE 115, a BS 105, or some other node) may convey SCI to another device (e.g., another UE 115, a BS 105, sidelink device or vehicle-to-everything (V2X) device, or other node). The SCI may be conveyed in one or more stages. The first stage SCI may be carried on the PSCCH while the second stage SCI may be carried on the corresponding PSSCH. For example, UE 115c may transmit a PSCCH/first stage SCI 235 (e.g., SCI-1) to each sidelink UE 115 in the network (e.g., UEs 115a and 115b) via the sidelink communication links 210. The PSCCH/first stage SCI-1 235 may indicate resources that are reserved by UE 115c for retransmissions (e.g., the SCI-1 may indicate the reserved resources 225 for retransmissions). Each sidelink UE 115 may decode the first stage SCI-1 to determine where the reserved resources 225 are located (e.g., to refrain from using resources that are reserved for another sidelink transmission and/or to reduce resource collision within the wireless communications network 200). Sidelink communication may include a mode 1 operation in which the UEs 115 are in a coverage area of BS 105a. In mode 1, the UEs 115 may receive a configured grant from the BS 105a that defines parameters for the UEs 115 to access the channel. Sidelink communication may also include a mode 2 operation in which the UEs 115 operate autonomously from the BS 105a and perform sensing of the channel to gain access to the channel. In some aspects, during mode 2 sidelink operations, the sidelink UEs 115 may perform channel sensing to locate resources reserved by other sidelink transmissions. The first stage SCI-1 may reduce the need for sensing each channel. For example, the first stage SCI-1 may include an explicit indication such that the UEs 115 may refrain from blindly decoding each channel. The first stage SCI-1 may be transmitted via the sidelink control resources 220. The sidelink control resources 220 may be configured resources (e.g., time resources or frequency resources) transmitted via a PSCCH 235. In some examples, the PSCCH 235 may be configured to occupy a number of physical resource blocks (PRBs) within a selected frequency. The frequency may include a single subchannel 250 (e.g., 10, 12, 15, 20, 25, or some other number of RBs within the subchannel 250). The time duration of the PSCCH 235 may be configured by the BS 105a (e.g., the PSCCH 235 may span 1, 2, 3, or some other number of symbols 255).

The first stage SCI-1 may include one or more fields to indicate a location of the reserved resources 225. For example, the first stage SCI-1 may include, without limitation, one or more fields to convey a frequency domain resource allocation (FDRA), a time domain resource allocation (TDRA), a resource reservation period 245 (e.g., a period for repeating the SCI transmission and the corresponding reserved resources 225), a modulation and coding scheme (MCS) for a second stage SCI-2 240, a beta offset value for the second stage SCI-2 240, a DMRS port (e.g., one bit indicating a number of data layers), a physical sidelink feedback channel (PSFCH) overhead indicator, a priority, one or more additional reserved bits, or a combination thereof. The beta offset may indicate the coding rate for transmitting the second stage SCI-2 240. The beta offset may indicate an offset to the MCS index. The MCS may be indicated by an index ranging from 0 to 31. For example, if the MCS is set at index 16 indicating a modulation order of 4 and a coding rate of 378, the beta offset may indicate a value of 2 thereby setting the coding rate to 490 based on an MCS index of 18. In some examples, the FDRA may be a number of bits in the first stage SCI-1 that may indicate a number of slots 238 and a number of subchannels reserved for the reserved resources 225 (e.g., a receiving UE 115 may determine a location of the reserved resources 225 based on the FDRA by using the subchannel 250 including the PSCCH 235 and first stage SCI-1 as a reference). The TDRA may be a number of bits in the first stage SCI-1 (e.g., 5 bits, 9 bits, or some other number of bits) that may indicate a number of time resources reserved for the reserved resources 225. In this regard, the first stage SCI-1 may indicate the reserved resources 225 to the one or more sidelink UEs 115 in the wireless communication network 200.

In some aspects, a number of contiguous S-SSB slots are scheduled in an unlicensed frequency band within the network 200 for an S-SSB burst. The UE 115c may perform a listen-before-talk (LBT) procedure and transmit an S-SSB in one of the S-SSB slots to the UE 115b based on the LBT procedure being successful. The UE 115c may select the remaining S-SSB slots in the S-SSB burst as a sidelink resource or a part of a sidelink resource for PSCCH/PSSCH transmission. As such, spectral efficiency in sidelink communications is improved. Mechanisms for including S-SSB slots in sidelink resource pool within the network 200 are discussed in greater detail herein.

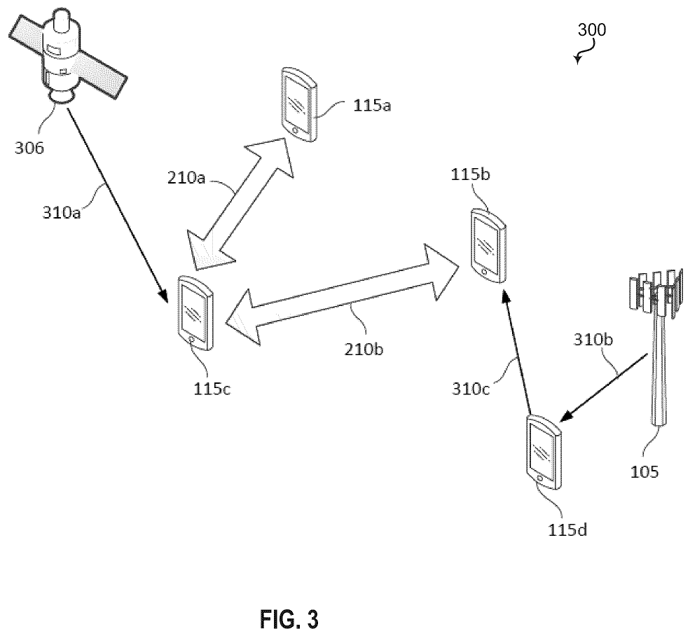

FIG. 3 illustrates synchronization (e.g., timing synchronization) sources for a sidelink wireless communication 300 according to some aspects of the present disclosure. In some aspects, the UE 115c may transmit an S-SSB(s) to support synchronization among the UEs 115 in the sidelink communication network 300. In some instances, the UE 115 that transmits the S-SSB may be referred to as a “sync UE” (e.g., a SyncRef UE), a “sidelink sync UE”, “anchor UE”, or “sidelink anchor UE”. The S-SSB transmitted by the sync UE 115 may include an automatic gain control (AGC) symbol, a sidelink primary synchronization signal (S-PSS), and a sidelink secondary synchronization signal (S-SSS). In some aspects, the UEs 115 may be in communication with a BS 105 or a global navigation satellite system (GNSS) 306 (e.g., a global positioning system) and receive the SSB(s) from the BS 105 over the link 310b or receive the GPS signal from the GNSS 306 over the link 310a in addition to and/or in lieu of receiving S-SSB(s) from one or more sync UEs 115. In some instances, the UEs 115a and 115b nearby the sync UE 115c may be out of communication range with the BS 105 or the GNSS 306 and may receive the S-SSB transmissions from the sync UE 115c over links 210a and 210b respectively. Thus, nearby UEs 115a and 115b may then receive the same sidelink timing reference and establish sidelink communication with the sync UE 115c and with nearby UEs 115 without needing to establish a communication link with the BS105 and/or the GNSS 306. In some aspects, the UE 115d may be in range of the BS 105 and may receive the SSB from the BS 105 over link 310b. Additionally or alternatively, the UE 115d may transmit an S-SSB(s) to the UE 115b over link 310c.

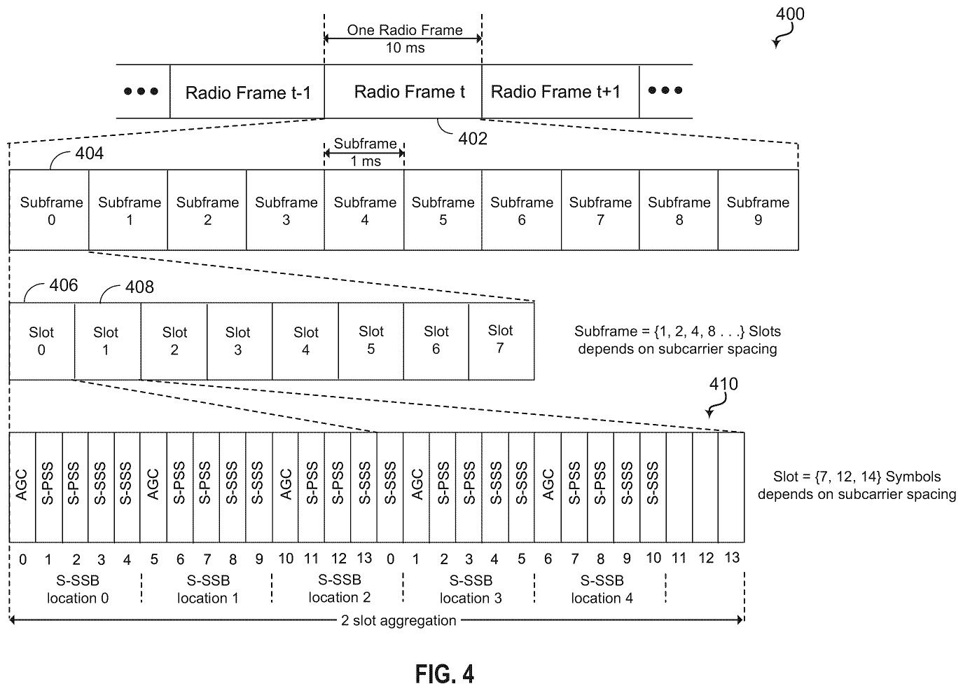

FIG. 4 is a diagram showing an example of a frame format 400. The transmission timeline for each data transmission and reception may be partitioned into units of radio frames 402. Each radio frame may have a predetermined duration (e.g., 10 ms) and may be partitioned into 10 subframes, each of 1 ms, with indices of 0 through 9. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 KHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, the subframe 404 (subframe 0) contains 8 slots (slots 0, 1, . . . , 7. The symbol and slot lengths scale with the subcarrier spacing. For the 120 kHz SCS shown in FIG. 4, each of the slot 406 (slot 0) and slot 408 (slot 1) includes 14 symbol periods (slots with indices 0, 1, . . . , 13).

In sidelink communications, S-SSBs are transmitted. The S-SSB may include a one-symbol AGC, a two-symbol sidelink primary SS (S-PSS), and a two-symbol sidelink secondary SS (S-SSS). In some instances, the S-SSB may further include a two-symbol physical sidelink broadcast channel (PSBCH). The AGC symbol may be used for AGC training. The S-PSS and S-SSS may be used by UEs to establish sidelink communication (e.g., transmission and/or reception of data and/or control channels). The S-PSS may provide half-frame timing, the SS may provide cyclic prefix (CP) length and frame timing. The PBSCH carries some basic system information, such as system bandwidth, timing information within radio frame, SS burst set periodicity, system frame number, etc. The S-SSBs may be organized into S-SSB bursts to support beam sweeping. Further system information such as, remaining minimum system information (RMSI), system information blocks (SIBs), and other system information (OSI) can be transmitted on a physical sidelink shared channel (PSSCH) in certain subframes.

In certain aspects, multiple S-SSBs may be transmitted in a number of contiguous slots. In some examples, the S-SSBs can be transmitted up to sixty-four times with up to sixty-four different beam directions. The contiguous slots assigned for S-SSBs are referred to as an S-SSB burst. The S-SSB burst may be periodically repeated. Multiple slots may be aggregated together. FIG. 4 also illustrates an example aggregation of two slots 406 and 408 to form an S-SSB burst 410. The aggregated number of slots may also be larger than two. When slots are aggregated, more candidate locations can be assigned for S-SSB transmission. In the example shown in FIG. 4, in the slot 406 (slot 0), symbols 0, 1, 2, 3, 4 are assigned as candidate S-SSB location 0, symbols 5, 6, 7, 8, 9 are assigned as candidate S-SSB location 1; across the slots 406 and 408 (slots 0 and 1), symbols 10, 11, 12, 13 in the slot 406 (slot 0) and symbol 0 in the slot 408 (slot 1) are assigned as candidate S-SSB location 2; in the slot 408 (slot 1), symbols 1, 2, 3, 4, 5, are assigned as candidate S-SSB location 3; and in the slot 408 (slot 1), symbols 6, 7, 8, 9, 10 are assigned as candidate S-SSB location 4. In the slot 408 (slot 1), symbols 11, 12, 13 may be left as gaps during which no transmissions are performed. Thus, in the 2 slot aggregation as illustrated in FIG. 4, when the candidate S-SSB locations 0 through 4 are all used for S-SSB transmission, the corresponding S-SSB burst includes 2 S-SSB slots (406, 408) and 5 S-SSBs.

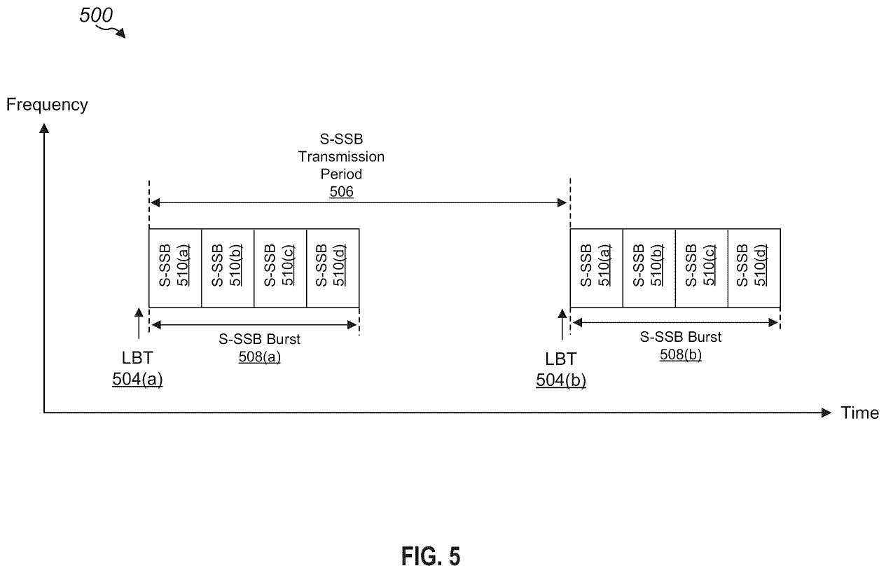

FIG. 5 illustrates an S-SSB transmission configuration 500 according to some aspects of the present disclosure. In FIG. 5, the x-axis represents time in some arbitrary units and the y-axis represents frequency in some arbitrary units. In some aspects, a first sidelink UE (e.g., the UE 115 or the UE 1200) may transmit a first S-SSB burst 508(a) to a second sidelink UE. The first S-SSB 508(a) may include one or more aggregated slots to provide one or more candidate S-SSB locations. The first sidelink UE may transmit one or more S-SSB in the assigned candidate S-SSB locations. The first sidelink UE may receive a S-SSB configuration from a BS (e.g., the BS 105 or the network unit 1300) that indicates the time/frequency resources and candidate S-SSB locations for the transmissions of S-SSBs. In this regard, the first sidelink UE may receive the S-SSB configuration from the BS in a radio resource control (RRC) configuration, and/or other suitable communication. The first sidelink UE may transmit one or more S-SSBs in one or more candidate S-SSB locations in the first S-SSB burst 508(a). In FIG. 5, the first sidelink UE transmits the first S-SSB 510(a), the second S-SSB 510(b), the third S-SSB 510(c), and the fourth S-SSB 510(d) in four candidate S-SSB locations assigned in the first S-SSB burst 508(a).

In some aspects, the first sidelink UE (e.g., the UE 115 or the UE 1200) may perform a first listen-before-talk (LBT) procedure 504(a) in an unlicensed frequency band (e.g., a shared frequency band). The first sidelink UE may perform the LBT 504(a) to gain access to the communications channel in the unlicensed band to transmit the S-SSB(s) 510. The LBT 504(a) may be based on an LBT configuration received from the BS. The LBT configuration may include the type of LBT 504(a) (e.g., a frame-based equipment (FBE)-based LBT and/or a load-based equipment (LBE)-based LBT), the category of LBT (e.g., CAT2-LBT and/or CAT4-LBT), and/or at least one direction (e.g., a beam direction) associated with the LBT 504(a). In some aspects, the sidelink UE may periodically (e.g., at the S-SSB transmission periodicity 506) repeat the actions of performing an LBT 504 and transmitting the S-SSBs 510 based on a successful LBT 504. For example, the S-SSB transmission periodicity 506 may be 160 ms. The first sidelink UE may perform a second LBT 504(b) and transmit a second S-SSB burst 508(b) to the second UE on a successful LBT 504(b).

A sidelink sync UE may be configured to periodically transmit (e.g., broadcast) S-SSBs or other communication signals to other sidelink UEs to enable synchronized communication between the sidelink UEs. In some instances, the first sidelink UE may periodically transmit the S-SSBs 510 in candidate S-SSB locations in an S-SSB burst 508 at a periodicity based on an S-SSB transmission periodicity 506. In some aspects, the first sidelink UE may transmit a PSSCH and/or a PSCCH communication along with the S-SSBs. However, in some instances, one or more of the aggregated S-SSB slots in an S-SSB burst may be not utilized for S-SSB transmissions and left blank, but the first UE may not transmit a PSSCH and/or a PSCCH communication utilizing these unused S-SSB slots. This is because these unused S-SSB slots have been assigned for S-SSB transmissions and not included in sidelink resource pool. Accordingly, certain spectral resources are wasted.

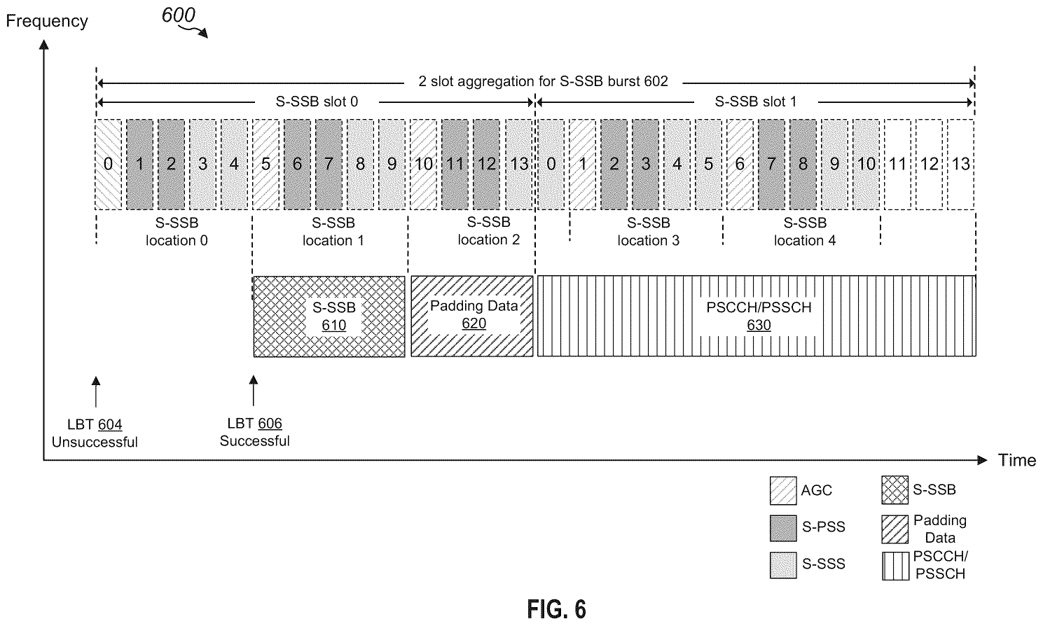

FIG. 6 illustrates an example of a resource configuration 600 that supports sidelink resource pool to include S-SSB slots according to some aspects of the present disclosure. In FIG. 6, the x-axis represents time in some arbitrary units. The y-axis represents frequency in some arbitrary units. In some aspects, a first sidelink UE (e.g., the UE 115, or the UE 1200) may transmit a configuration to a second sidelink UE (e.g., the UE 115, or the UE 1200). The configuration may indicate whether S-SSB slots are included in sidelink resource pool. Such an indication may be a one-bit flag SL-SSB-Slots-Included For example, the flag SL-SSB-Slots-Included being “1” may indicate S-SSB slots being included in sidelink resource pool, while the flag SL-SSB-Slots-Included being “0” may indicate S-SSB slots being excluded from sidelink resource pool. In this regard, the first sidelink UE may transmit the configuration to the second sidelink UE via a PC5 communication, sidelink control information (e.g., SCI-1, SCI-2), a radio resource control (RRC) communication, or other suitable communication. Additionally or alternatively, the first sidelink UE may receive the configuration from a network unit (e.g., the BS 105, or the network unit 1300) via downlink control information (DCI), a radio resource control (RRC) communication, or other suitable communication. The first sidelink UE may transmit (e.g., forward) the configuration received from the network unit to the second sidelink UE. In some instances, the first sidelink UE is a sidelink sync UE, and the second sidelink UE is a sidelink non-sync UE.

In some aspects, the configuration may also indicate a number of contiguous S-SSB slots and candidate S-SSB locations associated with an S-SSB burst 602. For example, in FIG. 6 the configuration may indicate a length of 2 slots (S-SSB slots 0 and 1) aggregated to form an S-SSB burst 602. Additionally or alternatively, the configuration may indicate more than 2 slots associated with the S-SSB burst 602. The slots associated with the S-SSB burst 602 may be contiguous in time and have consecutive slot indexes (e.g., slots with indices 0, 1, . . N). A slot may include a number of symbols (e.g., symbols with indices 0, 1, . . . , 13). In the example shown in FIG. 6, in the S-SSB slot 0, symbols 0, 1, 2, 3, 4 are assigned as candidate S-SSB location 0, symbols 5, 6, 7, 8, 9 are assigned as candidate S-SSB location 1; across the S-SSB slots 0 and 1, symbols 10, 11, 12, 13 in the S-SSB slot 0 and symbol 0 in the S-SSB slot 1 are assigned as candidate S-SSB location 2; in the S-SSB slot 1, symbols 1, 2, 3, 4, 5, are assigned as candidate S-SSB location 3; and in the S-SSB slot 1, symbols 6, 7, 8, 9, 10 are assigned as candidate S-SSB location 4. In the S-SSB slot 1, symbols 11, 12, 13 may be assigned as gaps. Thus, in the 2 slot aggregation as illustrated in FIG. 6, the S-SSB burst 602 includes 2 aggregated S-SSB slots 0 and 1 providing 5 contiguous candidate S-SSB locations. .

In some aspects, the first sidelink UE may perform a listen-before-talk (LBT) or other clear channel assessment (CCA) prior to transmitting an S-SSB 610. Particularly, the first sidelink UE may perform an LBT (or other CCA) to gain access to a channel occupancy time (COT) in an unlicensed spectrum. For example, the first sidelink UE may perform a category 1 LBT, a category 2 LBT, a category 3 LBT, and/or a category 4 LBT to gain access to a COT in an unlicensed spectrum. As shown in FIG. 6, if the first sidelink UE performs an LBT 604 before attempting to transmit the S-SSB 610 to the second sidelink UE using the candidate S-SSB location 0, the LBT 604 may fail. The failure of the LBT 604 may prevent the first sidelink UE from accessing the channel and transmitting the S-SSB 610 to the second sidelink UE using the candidate S-SSB location 0. The first sidelink UE may perform another LBT 606 before attempting to transmit the S-SSB 610 to the second sidelink UE using the candidate S-SSB location 1. If the LBT 606 is successful, then the first sidelink UE may proceed with transmitting the S-SSB 610 in the acquired COT using the candidate S-SSB location 1.

In some instances, the first sidelink UE may not utilize all the candidate S-SSB locations to transmit multiple S-SSBs. For example, the first sidelink UE may transmit a single S-SSB at one of the candidate S-SSB locations. If the flag SL-SSB-Slots-Include indicates S-SSB slots being included in sidelink resource pool, the first sidelink UE may use one or more remaining S-SSB slots in the S-SSB burst 602 for PSCCH/PSSCH transmission.

In FIG. 6, the S-SSB 610 transmission is completed before an end of the associated S-SSB slot 0. If the remaining S-SSB slot 1 is within transmitting resource pool and the first sidelink UE has data to transmit, the first sidelink UE may transmit padding data (e.g., cyclic prefix extension (CPE)) 620 to pad until the end of the S-SSB slot 0 to block other UEs contending for the acquired COT. By transmitting the padding data 620 until the end of the S-SSB slot 0, the first sidelink UE retains the acquired COT. As shown in FIG. 6, the first sidelink UE may transmit padding data 620 in symbols 10, 11, 12, and 13 of the S-SSB slot 0. After padding the S-SSB slot 0, the first sidelink UE may start PSCCH/PSSCH transmission 630 at the beginning of the S-SSB slot 1. For example, the first sidelink UE may transmit sidelink control information (SCI) via a PSCCH and/or sidelink data via a PSSCH with a transmitting sidelink resource including the S-SSB slot 1. The PSCCH/PSSCH transmission 630 may be multicasting to multiple UEs in the network (e.g., the wireless communications network 100, 200, or 300), directed to one of the multiple UEs other than the second sidelink UE, or directed to the second sidelink UE.

The second sidelink UE may receive the S-SSB 610, and derive carrier frequency and slot timing from the S-SSB 610. The second sidelink UE may perform a synchronization process based on the derived carrier frequency and slot timing from the S-SSB 610. Alternatively, the second sidelink UE may perform the synchronization process base on a reference synchronization signal received from a GNSS or a reference synchronization signal received from a BS. In either instance, if remaining S-SSB slots are within transmitting resource pool for the second sidelink UE, the second sidelink UE may keep detecting S-SSB in remaining S-SSB slots to determine availability of remaining S-SSB slots for PSCCH/PSSCH transmission. If remaining S-SSB slots are within receiving resource pool for the second sidelink UE, the second sidelink UE may keep monitoring PSCCH in remaining S-SSB slots to determine whether there is data addressed to the second sidelink UE. For example, in FIG. 6, the second sidelink UE may keep monitoring SCI in the PSCCH of the PSCCH/PSSCH transmission 630. If the destination identifier (ID) indicated in the SCI identifies the second sidelink UE as a receiving sidelink UE, the second sidelink UE may proceed to receive corresponding sidelink data in the PSSCH of the PSCCH/PSSCH transmission 630.

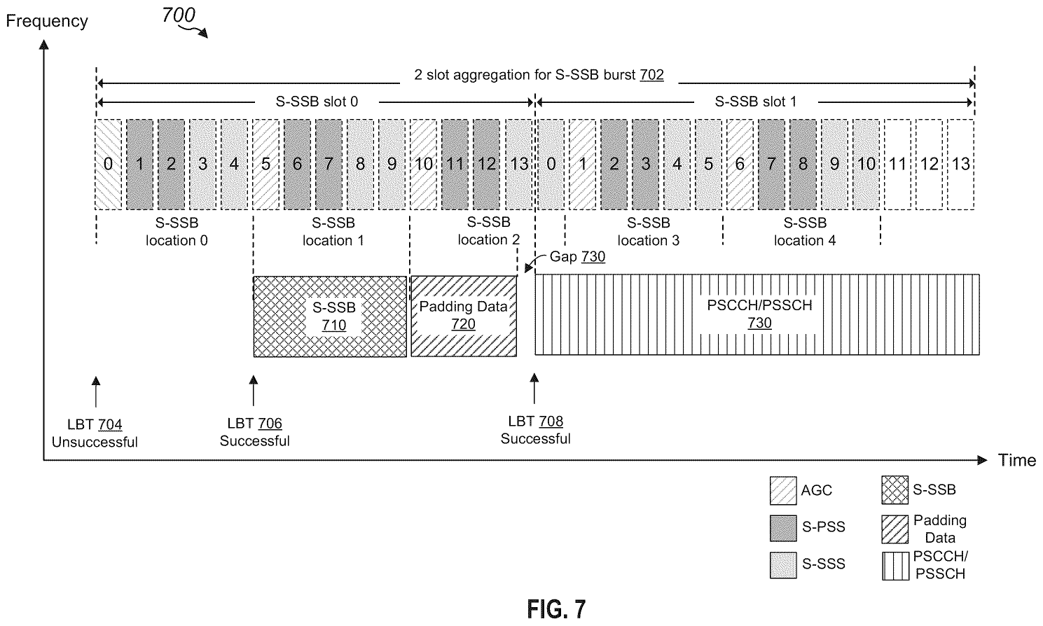

FIG. 7 illustrates an example of a resource configuration 700 that supports sidelink resource pool to include S-SSB slots according to some aspects of the present disclosure. In FIG. 7, the x-axis represents time in some arbitrary units. The y-axis represents frequency in some arbitrary units. In some aspects, a first sidelink UE (e.g., the UE 115, or the UE 1200) may transmit a configuration to a second sidelink UE (e.g., the UE 115, or the UE 1200). The configuration may indicate whether S-SSB slots are included in sidelink resource pool. Such an indication may be a one-bit flag SL-SSB-Slots-Included For example, the flag SL-SSB-Slots-Include being “1” may indicate S-SSB slots being included in sidelink resource pool, while the flag SL-SSB-Slots-Include being “0” may indicate S-SSB slots being excluded from sidelink resource pool. In this regard, the first sidelink UE may transmit the configuration to the second sidelink UE via a PC5 communication, sidelink control information (e.g., SCI-1, SCI-2), a radio resource control (RRC) communication, or other suitable communication. Additionally or alternatively, the first sidelink UE may receive the configuration from a network unit (e.g., the BS 105, or the network unit 1300) via downlink control information (DCI), a radio resource control (RRC) communication, or other suitable communication. The first sidelink UE may transmit (e.g., forward) the configuration received from the network unit to the second sidelink UE. In some instances, the first sidelink UE is a sidelink sync UE, and the second sidelink UE is a sidelink non-sync UE.

In some aspects, the configuration may also indicate a number of contiguous S-SSB slots and candidate S-SSB locations associated with an S-SSB burst 702. For example, in FIG. 7 the configuration may indicate a length of 2 slots (S-SSB slots 0 and 1) aggregated to form an S-SSB burst 702. Additionally or alternatively, the configuration may indicate more than 2 slots associated with the S-SSB burst 702. The slots associated with the S-SSB burst 702 may be contiguous in time and have consecutive slot indexes (e.g., slots with indices 0, 1, . . N). A slot may include a number of symbols (e.g., symbols with indices 0, 1, . . . , 13). In the example shown in FIG. 7, in the S-SSB slot 0, symbols 0, 1, 2, 3, 4 are assigned as candidate S-SSB location 0, symbols 5, 6, 7, 8, 9 are assigned as candidate S-SSB location 1; across the S-SSB slots 0 and 1, symbols 10, 11, 12, 13 in the S-SSB slot 0 and symbol 0 in the S-SSB slot 1 are assigned as candidate S-SSB location 2; in the S-SSB slot 1, symbols 1, 2, 3, 4, 5, are assigned as candidate S-SSB location 3; and in the slot 1, symbols 6, 7, 8, 9, 10 are assigned as candidate S-SSB location 4. In the S-SSB slot 1, symbols 11, 12, 13 may be assigned as gaps. Thus, in the 2 slot aggregation as illustrated in FIG. 7, the S-SSB burst 702 includes 2 aggregated S-SSB slots 0 and 1 providing 5 contiguous candidate S-SSB locations. In some aspects, the number of aggregated S-SSB slots associated with the S-SSB burst 702 may be based on a number of UEs the first sidelink UE is scheduled to transmit the S-SSB 710 to.

In some aspects, the first sidelink UE may perform a listen-before-talk (LBT) or other clear channel assessment (CCA) prior to transmitting an S-SSB 710. Particularly, the first sidelink UE may perform an LBT (or other CCA) to gain access to a channel occupancy time (COT) in an unlicensed spectrum. For example, the first sidelink UE may perform a category 1 LBT, a category 2 LBT, a category 3 LBT, and/or a category 4 LBT to gain access to a COT in an unlicensed spectrum. As shown in FIG. 7, if the first sidelink UE performs an LBT 704 before attempting to transmit the S-SSB 710 to the second sidelink UE using the candidate S-SSB location 0, the LBT 604 may fail. The failure of the LBT 704 may prevent the first sidelink UE from accessing the channel and transmitting the S-SSB 710 to the second sidelink UE using the candidate S-SSB location 0. The first sidelink UE may perform another LBT 706 before attempting to transmit the S-SSB 710 to the second sidelink UE using the candidate S-SSB location 1. If the LBT 706 is successful, then the first sidelink UE may proceed with transmitting the S-SSB 710 in the acquired COT using the candidate S-SSB location 1.

In some instances, the first sidelink UE may not utilize all the candidate S-SSB locations to transmit multiple S-SSBs. For example, the first sidelink UE may transmit a single S-SSB at one of the candidate S-SSB locations. If the flag SL-SSB-Slots-Include indicates S-SSB slots being included in sidelink resource pool, the first sidelink UE may use one or more remaining S-SSB slots in the S-SSB burst 602 for PSCCH/PSSCH transmission.

In FIG. 7, the S-SSB 710 transmission is completed before an end of the associated S-SSB slot 0. If the remaining S-SSB slot 1 is within receiving resource pool for the first sidelink UE or the first sidelink UE has no data to transmit, the first sidelink UE may transmit padding data (e.g., cyclic prefix extension (CPE)) 720 to pad until a gap 730 before the end of the S-SSB slot 0 to block other UEs contending for the acquired COT. By transmitting the padding data 720, the first sidelink UE retains the acquired COT until the end of the S-SSB slot 0. Meanwhile, the gap 730 leaves interval for the first sidelink UE to switch to receiving mode and also allows other sidelink UEs, such as the second sidelink UE, to contend for the shared COT starting from the S-SSB slot 1. As shown in FIG. 7, the first sidelink UE may transmit padding data 620 in symbols 10, 11, 12, and a portion of the symbol 13 of the S-SSB slot 0. After padding, the first sidelink UE may switch to a receiving mode and start monitoring PSCCH/PSSCH transmission from another sidelink UE in one or more of the remaining S-SSB slots in the S-SSB burst 702, such as the PSCCH/PSSCH transmission 730 from the second sidelink UE in the example as shown in FIG. 7.

The second sidelink UE may receive the S-SSB 710, and derive carrier frequency and slot timing from the S-SSB 710. The second sidelink UE may perform a synchronization process based on the derived carrier frequency and slot timing from the S-SSB 710. Alternatively, the second sidelink UE may perform the synchronization process base on a reference signal received from a GNSS or a reference signal received from a BS. In either instance, if remaining S-SSB slots are within transmitting resource pool for the second sidelink UE, the second sidelink UE may keep detecting S-SSB in remaining S-SSB slots to determine availability of remaining S-SSB slots for PSCCH/PSSCH transmission. If remaining S-SSB slots are within receiving resource pool for the second sidelink UE, the second sidelink UE may keep monitoring PSCCH in remaining S-SSB slots to determine whether there is data addressed to the second sidelink UE. For example, in FIG. 7, remaining S-SSB slots are within transmitting resource pool for the second sidelink UE and the second sidelink UE has data to transmit, the second sidelink UE may perform an LBT 708 before attempting to transmit the PSCCH/PSSCH transmission 730. If the LBT 708 is successful, then the second sidelink UE may proceed with transmitting the PSCCH/PSSCH transmission 730 in the shared COT using the S-SSB slot 1. The PSCCH/PSSCH transmission 730 may be multicasting to multiple UEs in the network (e.g., the wireless communications network 100, 200, or 300), directed to one of the multiple UEs other than the first sidelink UE, or directed to the first sidelink UE.

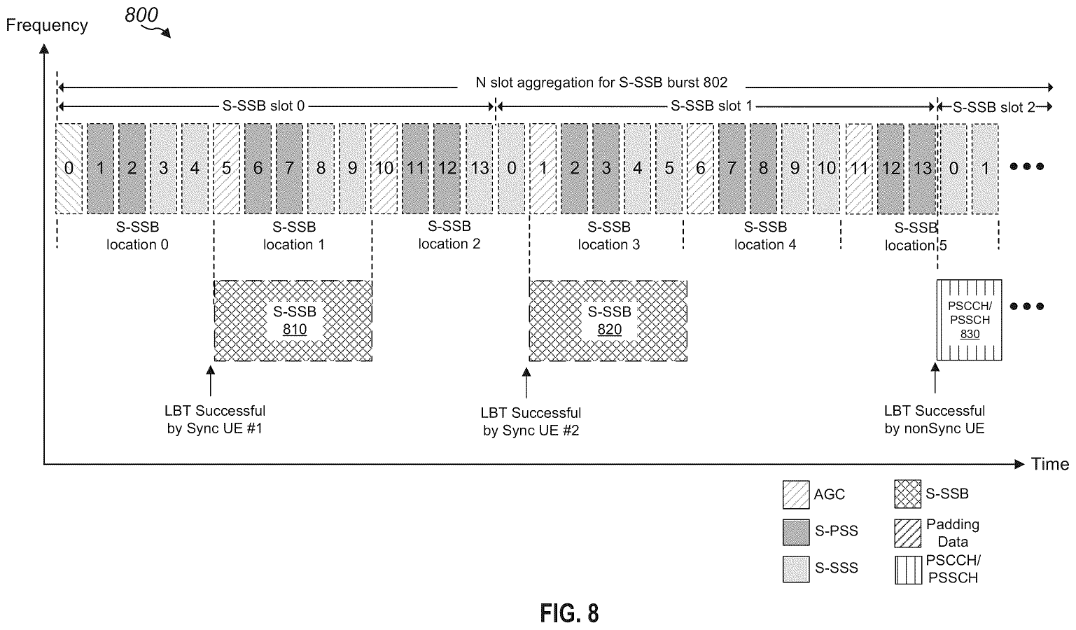

FIG. 8 illustrates an example of a resource configuration 800 that supports sidelink resource pool to include S-SSB slots according to some aspects of the present disclosure. In FIG. 8, the x-axis represents time in some arbitrary units. The y-axis represents frequency in some arbitrary units. In some instances, the sidelink communications may involve more than one sidelink sync UEs. For example, in FIG. 3, the UE 115c is a first sync UE in synchronization with reference signals transmitted from the GNSS 306, and the UE 115d is a second sync UE in synchronization with reference signals transmitted from the BS 105. Each of the sidelink sync UEs may transmit S-SSB(s), and a sidelink non-sync UE may receive S-SSB(s) from multiple sidelink sync UEs.

Referring back to FIG. 8, in some aspects, a first sidelink sync UE (e.g., the UE 115, or the UE 1200) may transmit a configuration to a sidelink non-sync UE (e.g., the UE 115, or the UE 1200). The configuration may indicate whether S-SSB slots are included in sidelink resource pool. Such an indication may be a one-bit flag SL-SSB-Slots-Included For example, the flag SL-SSB-Slots-Included being “1” may indicate S-SSB slots being included in sidelink resource pool, while the flag SL-SSB-Slots-Included being “0” may indicate S-SSB slots being excluded from sidelink resource pool. The configuration may further indicate whether a sidelink sync UE is allowed to transmit PSCCH/PSSCH in the remaining S-SSB slots. Such an indication may be a second one-bit flag PSCCH/PSSCH-Transmission-Allowed. For example, the flag PSCCH/PSSCH-Transmission-Allow ed being “1” may indicate PSCCH/PSSCH transmission by a sidelink sync UE being allowed, while the flag P SCCH/PSSCH-Transmission-Allow ed being “0” may indicate PSCCH/PSSCH transmission by a sidelink sync UE being disallowed. Notably, a sidelink sync UE disallowed to transmit PSCCH/PSSCH transmission in S-SSB slots may still monitor and receive PSCCH/PSSCH transmission in S-SSB slots from a sidelink non-sync UE. In this regard, the first sidelink sync UE may transmit the configuration to the sidelink non-sync UE via a PC5 communication, sidelink control information (e.g., SCI-1, SCI-2), a radio resource control (RRC) communication, or other suitable communication. Additionally or alternatively, the first sidelink sync UE may receive the configuration from a network unit (e.g., the BS 105, or the network unit 1300) via downlink control information (DCI), a radio resource control (RRC) communication, or other suitable communication. The first sidelink UE may transmit (e.g., forward) the configuration received from the network unit to the second sidelink UE. In some instances, the sidelink communications involves a second sidelink sync UE. The second sidelink sync UE may receive the same configuration from the network unit (e.g., the BS 105, or the network unit 1300) via downlink control information (DCI), a radio resource control (RRC) communication, or other suitable communication. Additionally or alternatively, the second sidelink sync UE may receive the configuration from the first sidelink sync UE via a PC5 communication, sidelink control information (e.g., SCI-1, SCI-2), a radio resource control (RRC) communication, or other suitable communication.

In some aspects, the configuration may also indicate a number of contiguous S-SSB slots and candidate S-SSB locations associated with an S-SSB burst 802. For example, in FIG. 8 the configuration may indicate a length of N slots (S-SSB slots 0, 1, 2, . . . N) aggregated to form an S-SSB burst 802. The slots associated with the S-SSB burst 802 may be contiguous in time and have consecutive slot indexes (e.g., slots with indices 0, 1, . . N). A slot may include a number of symbols (e.g., symbols with indices 0, 1, . . . , 13). In the example shown in FIG. 8, in the S-SSB slot 0, symbols 0, 1, 2, 3, 4 are assigned as candidate S-SSB location 0, symbols 5, 6, 7, 8, 9 are assigned as candidate S-SSB location 1; across the S-SSB slots 0 and 1, symbols 10, 11, 12, 13 in the S-SSB slot 0 and symbol 0 in the S-SSB slot 1 are assigned as candidate S-SSB location 2; in the S-SSB slot 1, symbols 1, 2, 3, 4, 5, are assigned as candidate S-SSB location 3; in the S-SSB slot 1, symbols 6, 7, 8, 9, 10 are assigned as candidate S-SSB location 4; and across the S-SSB slots 1 and 2, symbols 11, 12, 13 in the S-SSB slot 1 and symbols 0, 1 in the S-SSB slot 2 are assigned as candidate S-SSB location 5. In some aspects, the number of aggregated S-SSB slots associated with the S-SSB burst 802 may be based on a number of UEs the first sidelink sync UE is scheduled to transmit the S-SSB 810 to.

In some aspects, the first sidelink sync UE may perform a listen-before-talk (LBT) or other clear channel assessment (CCA) prior to transmitting an S-SSB 810. Particularly, the first sidelink sync UE may perform an LBT (or other CCA) to gain access to a channel occupancy time (COT) in an unlicensed spectrum. For example, the first sidelink sync UE may perform a category 1 LBT, a category 2 LBT, a category 3 LBT, and/or a category 4 LBT to gain access to a COT in an unlicensed spectrum. If the LBT is successful, then the first sidelink sync UE may proceed with transmitting the S-SSB 810 in the acquired COT using the candidate S-SSB location 1. The second sidelink sync UE may also perform a listen-before-talk (LBT) or other clear channel assessment (CCA) prior to transmitting an S-SSB 820. Particularly, the second sidelink sync UE may perform an LBT (or other CCA) to gain access to the shared COT initiated by the first sidelink sync UE. For example, the second sidelink sync UE may perform a category 1 LBT, a category 2 LBT, a category 3 LBT, and/or a category 4 LBT to gain access to the shared COT in an unlicensed spectrum. If the LBT is successful, then the second sidelink sync UE may proceed with transmitting the S-SSB 820 in the shared COT using the candidate S-SSB location 3. For the example in FIG. 8, the flag PSCCH/PSSCH-Transmission-Allowed may be “0” indicating PSCCH/PSSCH transmission by either the first sidelink sync UE or the second sidelink sync UE being disallowed. If the flag PSCCH/PSSCH-Transmission-Allowed is “1”, the first sidelink sync UE and the second sidelink sync UE may contend for sending the PSCCH/PSSCH transmission through a new round of LBT processes.

The sidelink non-sync UE may receive the S-SSB 810 and the S-SSB 820. The sidelink non-sync UE may derive carrier frequency and slot timing from one of the S-SSB 810 and the S-SSB 820. The second sidelink UE may perform a synchronization process based on the derived carrier frequency and slot timing from the respective S-SSB. Alternatively, the sidelink non-sync UE may perform the synchronization process base on a reference synchronization signal received from a GNSS or a reference synchronization signal received from a BS.

The sidelink non-sync UE may gain knowledge of a set of sidelink sync UEs around it based on previous S-SSB receptions. The sidelink non-sync UE may transmit PSCCH/PSSCH transmission only after it determines S-SSBs from all the sidelink sync UEs in the set are received in the current S-SSB burst. For example, in FIG. 8, the sidelink non-sync UE may know the set of sidelink sync UEs includes the first sidelink sync UE and the second sidelink sync UE from a previous S-SSB burst (e.g., an S-SSB burst occurred one S-SSB transmission period prior to the current S-SSB burst 802). After the sidelink non-sync UE receives the S-SSB 810 from the first sidelink sync UE and the S-SSB 820 from the second sidelink sync UE, the sidelink non-sync UE is aware that there is no more S-SSB in the remaining S-SSB slots in the current S-SSB burst 802. If the remaining S-SSB slots are within transmitting resource pool for the sidelink non-sync UE and the sidelink non-sync UE has data to transmit, the sidelink non-sync UE may perform an LBT before attempting to transmit the PSCCH/PSSCH transmission 830. If the LBT is successful, then the sidelink non-sync UE may proceed with transmitting the PSCCH/PSSCH transmission 830 in the shared COT using the S-SSB slot 2. The PSCCH/PSSCH transmission 830 may be multicasting to multiple UEs in the network (e.g., the wireless communications network 100, 200, or 300), directed to one of the multiple UEs other than the first sidelink sync UE, or directed to the first sidelink sync UE.

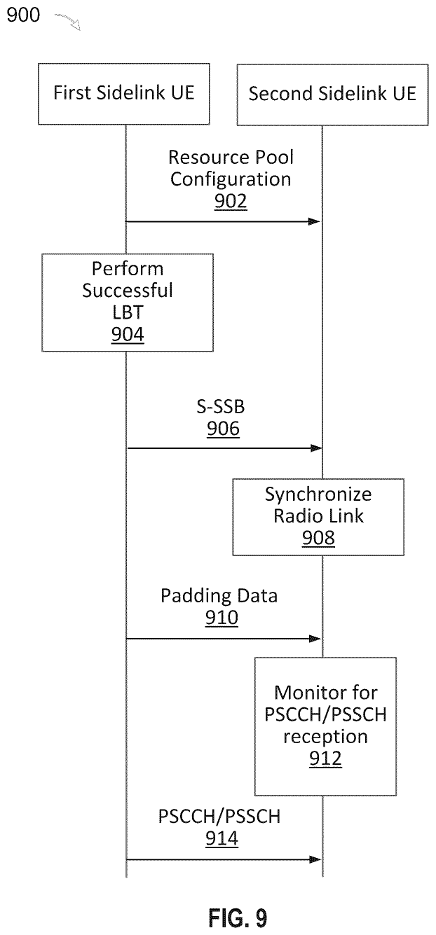

FIG. 9 is a signaling diagram of a wireless communication method 900 according to some aspects of the present disclosure. Actions of the communication method 900 can be executed by a computing device (e.g., a processor, processing circuit, and/or other suitable component) of a communication device or other suitable means for performing the actions. For example, a wireless communication device, such as the UE 115 or UE 1200, may utilize one or more components, such as the processor 1202, the memory 1204, the dynamic S-SSB module 1208, the transceiver 1210, the modem 1212, and the one or more antennas 1216, to execute aspects of method 900.

At action 902, the first sidelink UE (e.g., a sidelink sync UE) may transmit a sidelink resource pool configuration to the second sidelink UE (e.g., a sidelink non-sync UE). The configuration may indicate whether S-SSB slots are included in sidelink resource pool. In this regard, the first sidelink UE may transmit the configuration to the second sidelink UE via a PC5 communication, sidelink control information (e.g., SCI-1, SCI-2), a radio resource control (RRC) communication, or other suitable communication. Additionally or alternatively, the first sidelink UE may receive the configuration from a network unit (e.g., the BS 105, or the network unit 1300) via downlink control information (DCI), a radio resource control (RRC) communication, or other suitable communication. The first sidelink UE may transmit (e.g., forward) the configuration received from the network unit to the second sidelink UE.

At action 904, the first sidelink UE may perform a successful LBT. In this regard, the first sidelink UE may perform a LBT procedure to gain access to the channel in unlicensed frequency spectrum. For example, the first sidelink UE may perform a category 1 LBT, a category 2 LBT, a category 3, LBT and/or a category 4 LBT to gain access to the channel in the unlicensed frequency spectrum.

At action 906, the first sidelink UE may transmit an S-SSB to the second sidelink UE. The first sidelink UE may transmit the S-SSB based on performing a successful LBT at action 904. If the LBT is successful, then the first sidelink UE may transmit the S-SSB in a candidate S-SSB location in a S-SSB burst. The S-SSB burst may include a number of contiguous S-SSB slots.

At action 908, the second sidelink UE may receive the S-SSB from the first sidelink UE and derive carrier frequency and slot timing from the S-SSB. Alternatively, the sidelink UE may disregard the S-SSB and use reference synchronization signals received from a GNSS or a BS to perform the synchronization process.

At action 910, the first sidelink UE may transmit padding data to fill the gap between an end of the transmission of the S-SSB (i.e., the end of the last symbol of the candidate S-SSB location for the S-SSB transmission) and an end of the current S-SSB slot in which the last symbol of the candidate S-SSB location for the S-SSB transmission resides. The padding data blocks other UEs contending for the acquired COT. By transmitting the padding data until the end of the current S-SSB slot, the first sidelink UE retains the acquired COT.

At action 912, the second sidelink UE may keep monitoring PSCCH in remaining S-SSB slots of the current S-SSB burst to determine whether there is data addressed to the second sidelink UE.

At action 914, the first sidelink UE may start PSCCH/PSSCH transmission at one of the remaining S-SSB slots of the current S-SSB burst. For example, the PSCCH/PSSCH transmission may start at the first symbol of the first remaining S-SSB slot after the previous S-SSB slot used for the S-SSB transmission. The PSCCH/PSSCH transmission may takes one or more of the remaining S-SSB slots. The PSCCH/PSSCH transmission may be multicasting to multiple UEs, directed to one of the multiple UEs other than the second sidelink UE, or directed to the second sidelink UE.

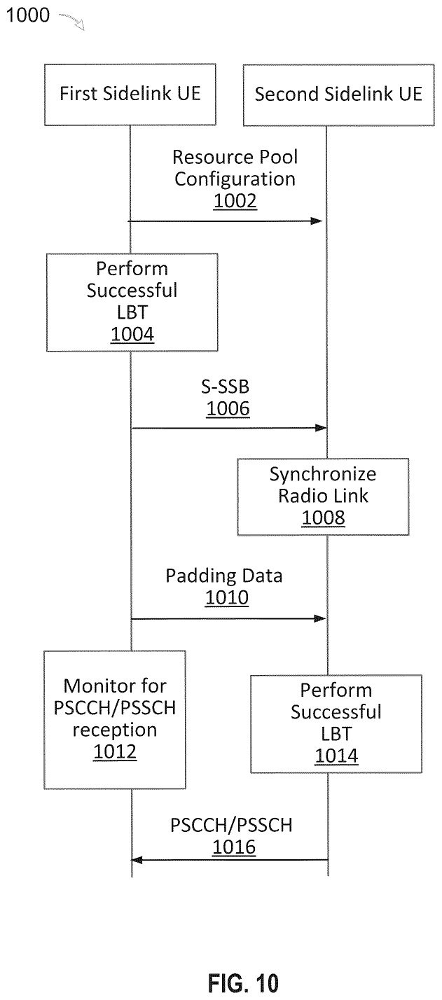

FIG. 10 is a signaling diagram of a wireless communication method 1000 according to some aspects of the present disclosure. Actions of the communication method 1000 can be executed by a computing device (e.g., a processor, processing circuit, and/or other suitable component) of a communication device or other suitable means for performing the actions. For example, a wireless communication device, such as the UE 115 or UE 1200, may utilize one or more components, such as the processor 1202, the memory 1204, the dynamic S-SSB module 1208, the transceiver 1210, the modem 1212, and the one or more antennas 1216, to execute aspects of method 1000.

At action 1002, the first sidelink UE (e.g., a sidelink sync UE) may transmit a sidelink resource pool configuration to the second sidelink UE (e.g., a sidelink non-sync UE). The configuration may indicate whether S-SSB slots are included in sidelink resource pool. In this regard, the first sidelink UE may transmit the configuration to the second sidelink UE via a PC5 communication, sidelink control information (e.g., SCI-1, SCI-2), a radio resource control (RRC) communication, or other suitable communication. Additionally or alternatively, the first sidelink UE may receive the configuration from a network unit (e.g., the BS 105, or the network unit 1300) via downlink control information (DCI), a radio resource control (RRC) communication, or other suitable communication. The first sidelink UE may transmit (e.g., forward) the configuration received from the network unit to the second sidelink UE.

At action 1004, the first sidelink UE may perform a successful LBT. In this regard, the first sidelink UE may perform a LBT procedure to gain access to the channel in unlicensed frequency spectrum. For example, the first sidelink UE may perform a category 1 LBT, a category 2 LBT, a category 3, LBT and/or a category 4 LBT to gain access to the channel in the unlicensed frequency spectrum.

At action 1006, the first sidelink UE may transmit an S-SSB to the second sidelink UE. The first sidelink UE may transmit the S-SSB based on performing a successful LBT at action 1004. If the LBT is successful, then the first sidelink UE may transmit the S-SSB in a candidate S-SSB location in a S-SSB burst. The S-SSB burst may include a number of contiguous S-SSB slots.

At action 1008, the second sidelink UE may receive the S-SSB from the first sidelink UE and derive carrier frequency and slot timing from the S-SSB. Alternatively, the sidelink UE may disregard the S-SSB and use reference synchronization signals received from a GNSS or a BS to perform the synchronization process.

At action 1010, the first sidelink UE may transmit padding data starting from an end of the transmission of the S-SSB (i.e., the end of the last symbol of the candidate S-SSB location for the S-SSB transmission) until a gap before an end of the S-SSB slot in which the last symbol of the candidate S-SSB location for the S-SSB transmission resides. The padding data blocks other UEs contending for the current S-SSB slot in the acquired COT. Meanwhile, the gap allows the first sidelink UE to switch to a receiving mode and allows other sidelink UE to perform LBT process to contend for the next S-SSB slot for PSCCH/PSSCH transmission.

At action 1012, the first sidelink UE may keep monitoring PSCCH in remaining S-SSB slots of the current S-SSB burst to determine whether there is data addressed to the first sidelink UE.

At action 1014, a second sidelink UE may perform a successful LBT. In this regard, the second sidelink UE may perform a LBT procedure to gain access to one of the remaining S-SSB slots in the current S-SSB burst. For example, the second sidelink UE may perform a category 1 LBT, a category 2 LBT, a category 3, LBT and/or a category 4 LBT to gain access to one of the remaining S-SSB slots in the current S-SSB burst.

At action 1016, the second sidelink UE may start PSCCH/PSSCH transmission at one of the remaining S-SSB slots of the current S-SSB burst. For example, the PSCCH/PSSCH transmission may start at the first symbol of the first remaining S-SSB slot after the previous S-SSB slot used for the S-SSB transmission. The PSCCH/PSSCH transmission may takes one or more of the remaining S-SSB slots. The PSCCH/PSSCH transmission may be multicasting to multiple UEs, directed to one of the multiple UEs other than the first sidelink UE, or directed to the first sidelink UE.

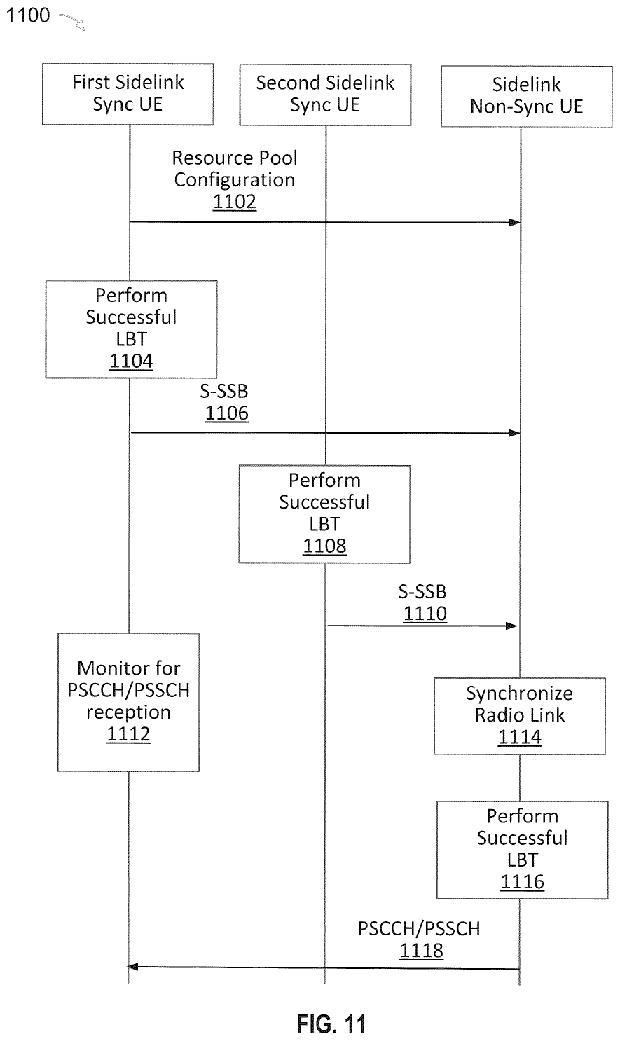

FIG. 11 is a signaling diagram of a wireless communication method 1100 according to some aspects of the present disclosure. Actions of the communication method 1100 can be executed by a computing device (e.g., a processor, processing circuit, and/or other suitable component) of a communication device or other suitable means for performing the actions. For example, a wireless communication device, such as the UE 115 or UE 1200, may utilize one or more components, such as the processor 1202, the memory 1204, the dynamic S-SSB module 1208, the transceiver 1210, the modem 1212, and the one or more antennas 1216, to execute aspects of method 1100.

At action 1102, the first sidelink sync UE may transmit a sidelink resource pool configuration to the second sidelink UE (e.g., a sidelink non-sync UE). The configuration may indicate whether S-SSB slots are included in sidelink resource pool. The configuration may further indicate whether sidelink sync UEs may transmit PSCCH/PSSCH transmission in S-SSB slots. In this regard, the first sidelink sync UE may transmit the configuration to the sidelink non-sync UE via a PC5 communication, sidelink control information (e.g., SCI-1, SCI-2), a radio resource control (RRC) communication, or other suitable communication. Additionally or alternatively, the first sidelink sync UE may receive the configuration from a network unit (e.g., the BS 105, or the network unit 1300) via downlink control information (DCI), a radio resource control (RRC) communication, or other suitable communication. The first sidelink sync UE may transmit (e.g., forward) the configuration received from the network unit to the sidelink non-sync UE.

At action 1104, the first sidelink sync UE may perform a successful LBT. In this regard, the first sidelink sync UE may perform a LBT procedure to gain access to the channel in unlicensed frequency spectrum. For example, the first sidelink sync UE may perform a category 1 LBT, a category 2 LBT, a category 3, LBT and/or a category 4 LBT to gain access to the channel in the unlicensed frequency spectrum.

At action 1106, the first sidelink sync UE may transmit an S-SSB to the sidelink non-sync UE. The first sidelink sync UE may transmit the S-SSB based on performing a successful LBT at action 1104. If the LBT is successful, then the first sidelink sync UE may transmit the S-SSB in a candidate S-SSB location in a S-SSB burst. The S-SSB burst may include a number of contiguous S-SSB slots.

At action 1108, a second sidelink sync UE may perform a successful LBT. In this regard, the second sidelink sync UE may perform a LBT procedure to gain access to a candidate S-SSB location in the current S-SSB burst. For example, the second sidelink sync UE may perform a category 1 LBT, a category 2 LBT, a category 3, LBT and/or a category 4 LBT to gain access to the candidate S-SSB location in the current S-SSB burst.

At action 1110, the second sidelink sync UE may transmit an S-SSB to the sidelink non-sync UE. The second sidelink syncUE may transmit the S-SSB based on performing a successful LBT at action 1108. If the LBT is successful, then the second sidelink sync UE may transmit the S-SSB in the candidate S-SSB location in the current S-SSB burst.

At action 1112, the first sidelink sync UE may keep monitoring PSCCH in remaining S-SSB slots of the current S-SSB burst to determine whether there is data addressed to the first sidelink sync UE.

At action 1114, the sidelink non-sync UE may receive the S-SSB from the first sidelink sync UE and the S-SSB from the second sidelink sync UE. The sidelink non-sync UE may derive carrier frequency and slot timing from one of the received S-SSBs. Alternatively, the sidelink non-sync UE may disregard the received S-SSBs and use reference synchronization signals received from a GNSS or a BS to perform the synchronization process.

At action 1116, the sidelink non-sync UE may perform a successful LBT. In this regard, the second sidelink UE may perform a LBT procedure to gain access to one of the remaining S-SSB slots in the current S-SSB burst after the S-SSBs from all the known sidelink sync UEs are received. For example, the second sidelink UE may perform a category 1 LBT, a category 2 LBT, a category 3, LBT and/or a category 4 LBT to gain access to one of the remaining S-SSB slots in the current S-SSB burst.

At action 1118, the sidelink non-sync UE may start PSCCH/PSSCH transmission at one of the remaining S-SSB slots of the current S-SSB burst. For example, the PSCCH/PSSCH transmission may start at the first symbol of the first remaining S-SSB slot after the previous S-SSB slot used for the S-SSB transmission. The PSCCH/PSSCH transmission may takes one or more of the remaining S-SSB slots. The PSCCH/PSSCH transmission may be multicasting to multiple UEs, directed to one of the multiple UEs other than the first sidelink UE, or directed to the first sidelink UE.

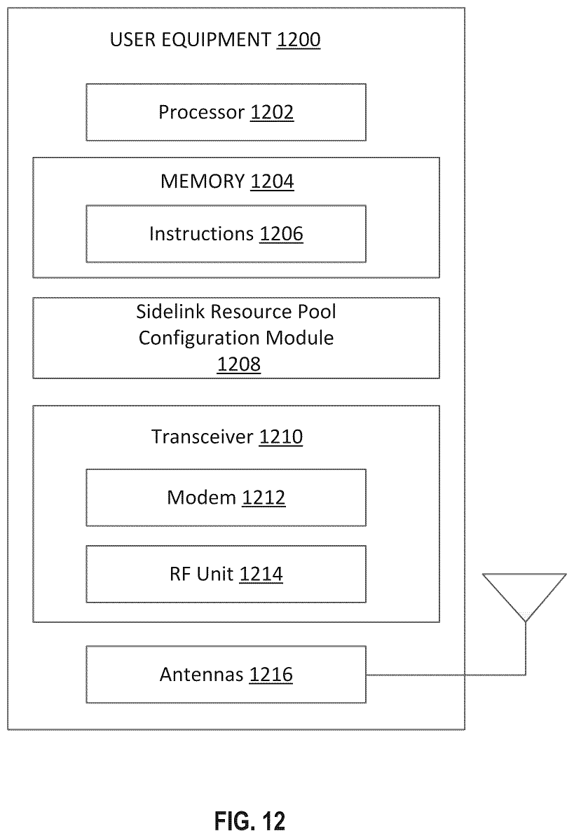

FIG. 12 is a block diagram of an exemplary UE 1200 according to some aspects of the present disclosure. The UE 1200 may be the UE 115 in the network 100, 200, or 300 as discussed above. As shown, the UE 1200 may include a processor 1202, a memory 1204, a sidelink resource pool configuration module 1208, a transceiver 1210 including a modem subsystem 1212 and a radio frequency (RF) unit 1214, and one or more antennas 1216. These elements may be coupled with each other and in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 1204 includes a non-transitory computer-readable medium. The memory 1204 may store instructions 1206. The instructions 1206 may include instructions that, when executed by the processor 1202, cause the processor 1202 to perform the operations described herein with reference to the UEs 115 in connection with aspects of the present disclosure, for example, aspects of FIGS. 4-11. Instructions 1206 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink resource pool configuration module 1208 may be implemented via hardware, software, or combinations thereof. For example, the sidelink resource pool configuration module 1208 may be implemented as a processor, circuit, and/or instructions 1206 stored in the memory 1204 and executed by the processor 1202. In some aspects, the sidelink resource pool configuration module 1208 may be used to transmit, to a second sidelink UE (e.g., the UE 115), a configuration indicating whether S-SSB slots are included in sidelink resource pool and/or whether sidelink sync UEs may transmit PSCCH/PSSCH transmission in S-SSB slots. The sidelink resource pool configuration may be part of an RRC configuration.

As shown, the transceiver 1210 may include the modem subsystem 1212 and the RF unit 1214. The transceiver 1210 can be configured to communicate bi-directionally with other devices, such as the BSs 105 and/or the UEs 115. The modem subsystem 1212 may be configured to modulate and/or encode the data from the memory 1204 and the according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data from the modem subsystem 1212 (on outbound transmissions) or of transmissions originating from another source such as a UE 115 or a BS 105. The RF unit 1214 may be further configured to perform analog beamforming in conjunction with the digital beamforming. Although shown as integrated together in transceiver 1210, the modem subsystem 1212 and the RF unit 1214 may be separate devices that are coupled together to enable the UE 1200 to communicate with other devices.

The RF unit 1214 may provide the modulated and/or processed data, e.g. data packets (or, more generally, data messages that may contain one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The antennas 1216 may include multiple antennas of similar or different designs in order to sustain multiple transmission links. The RF unit 1214 may configure the antennas 1216.

In some instances, the UE 1200 can include multiple transceivers 1210 implementing different RATs (e.g., NR and LTE). In some instances, the UE 1200 can include a single transceiver 1210 implementing multiple RATs (e.g., NR and LTE). In some instances, the transceiver 1210 can include various components, where different combinations of components can implement RATs.

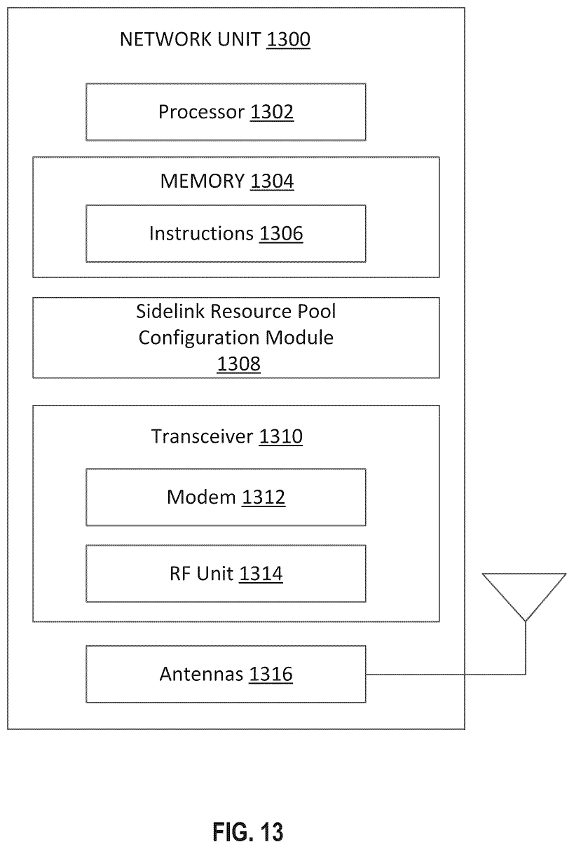

FIG. 13 is a block diagram of an exemplary network unit 1300 according to some aspects of the present disclosure. The network unit 1300 may be a BS 105 as discussed above. As shown, the network unit 1300 may include a processor 1302, a memory 1304, a sidelink resource pool configuration module 1308, a transceiver 1310 including a modem subsystem 1312 and a RF unit 1314, and one or more antennas 1316. These elements may be coupled with each other and in direct or indirect communication with each other, for example via one or more buses.

The processor 1302 may have various features as a specific-type processor. For example, these may include a CPU, a DSP, an ASIC, a controller, a FPGA device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1304 may include a non-transitory computer-readable medium. The memory 1304 may store instructions 1306. The instructions 1306 may include instructions that, when executed by the processor 1302, cause the processor 1302 to perform operations described herein, for example, aspects of FIGS. 4-11. Instructions 1306 may also be referred to as code, which may be interpreted broadly to include any type of computer-readable statement(s).

The sidelink resource pool configuration module 1308 may be implemented via hardware, software, or combinations thereof. For example, the sidelink resource pool configuration module 1308 may be implemented as a processor, circuit, and/or instructions 1306 stored in the memory 1304 and executed by the processor 1302. In some aspects, the sidelink resource pool configuration module 1308 may be used to transmit, to a first sidelink UE (e.g., the UE 115), a configuration indicating whether S-SSB slots are included in sidelink resource pool and/or whether sidelink sync UEs may transmit PSCCH/PSSCH transmission in S-SSB slots. The sidelink resource pool configuration may be part of an RRC configuration.

As shown, the transceiver 1310 may include the modem subsystem 1312 and the RF unit 1314. The transceiver 1310 can be configured to communicate bi-directionally with other devices, such as the UEs 115 or UE 1200. The modem subsystem 1312 may be configured to modulate and/or encode data according to a MCS, e.g., a LDPC coding scheme, a turbo coding scheme, a convolutional coding scheme, a digital beamforming scheme, etc. The RF unit 1314 may be configured to process (e.g., perform analog to digital conversion or digital to analog conversion, etc.) modulated/encoded data from the modem subsystem 1312 (on outbound transmissions) or of transmissions originating from another source such as a UE 115 or UE 1200. The RF unit 1314 may be further configured to perform analog beamforming in conjunction with the digital beamforming. Although shown as integrated together in transceiver 1310, the modem subsystem 1312 and/or the RF unit 1314 may be separate devices that are coupled together at the network unit 1300 to enable the network unit 1300 to communicate with other devices.

The RF unit 1314 may provide the modulated and/or processed data, e.g. data packets (or, more generally, data messages that may contain one or more data packets and other information), to the antennas 1316 for transmission to one or more other devices. This may include, for example, a configuration indicating a plurality of sub-slots within a slot according to aspects of the present disclosure. The antennas 1316 may further receive data messages transmitted from other devices and provide the received data messages for processing and/or demodulation at the transceiver 1310. The antennas 1316 may include multiple antennas of similar or different designs in order to sustain multiple transmission links.

In some instances, the network unit 1300 can include multiple transceivers 1310 implementing different RATs (e.g., NR and LTE). In some instances, the network unit 1300 can include a single transceiver 1310 implementing multiple RATs (e.g., NR and LTE). In some instances, the transceiver 1310 can include various components, where different combinations of components can implement RATs.

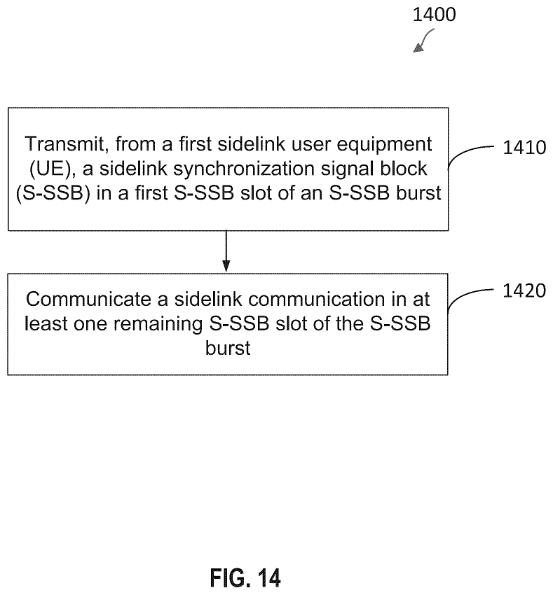

FIG. 14 is a flow diagram of a communication method 1400 according to some aspects of the present disclosure. Aspects of the method 1400 can be executed by a computing device (e.g., a processor, processing circuit, and/or other suitable component) of a wireless communication device or other suitable means for performing the aspects. For example, a wireless communication device, such as the UE 115 or the UE 1200, may utilize one or more components, such as the processor 1202, the memory 1204, the sidelink resource pool configuration module 1208, the transceiver 1210, the modem 1212, and the one or more antennas 1216, to execute aspects of method 1400. The method 1400 may employ similar mechanisms as in the networks 100, 200, and 300 and the aspects and actions described with respect to FIGS. 4-11. As illustrated, the method 1400 includes a number of enumerated aspects, but the method 1400 may include additional aspects before, after, and in between the enumerated aspects. In some aspects, one or more of the enumerated aspects may be omitted or performed in a different order.

At action 1410, the method 1400 includes a first sidelink UE (e.g., the UE 115 or the UE 1200) configured to transmit a sidelink synchronization signal block (S-SSB) in a first S-SSB slot of an S-SSB burst.

At action 1420, the method 1400 includes the first sidelink UE configured to communicate a sidelink communication in at least one remaining S-SSB slot of the S-SSB burst.

In some aspects, the communicating the sidelink communication includes transmitting at least one of sidelink control information (SCI) via a physical sidelink control channel (PSCCH) or sidelink data via a physical sidelink shared channel (PSSCH). In some aspects, the communicating the sidelink communication includes receiving at least one of sidelink control information (SCI) via a physical sidelink control channel (PSCCH) or sidelink data via a physical sidelink shared channel (PSSCH). In some aspects, the method 1400 further includes transmitting padding data during the first S-SSB slot based on the transmitting the S-SSB being completed before an end of the first S-SSB slot. In some aspects, the method 1400 further includes performing a listen-before-talk (LBT) procedure; and acquiring, based on the LBT procedure being successful, a channel occupancy time (COT), wherein the first S-SSB slot is within the COT. In some aspects, the communicating the sidelink communication is based, at least in part, on an indication in a radio resource control (RRC) configuration. In some aspects, the method 1400 further includes receiving the RRC configuration. In some aspects, the at least one remaining S-SSB slot is immediately after the first S-SSB slot.

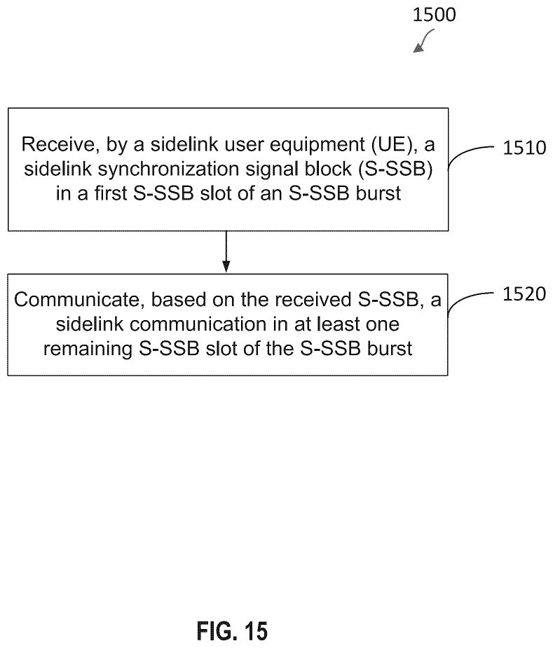

FIG. 15 is a flow diagram of a communication method 1500 according to some aspects of the present disclosure. Aspects of the method 1500 can be executed by a computing device (e.g., a processor, processing circuit, and/or other suitable component) of a wireless communication device or other suitable means for performing the aspects. For example, a wireless communication device, such as the UE 115 or the UE 1200, may utilize one or more components, such as the processor 1202, the memory 1204, the sidelink resource pool configuration module 1208, the transceiver 1210, the modem 1212, and the one or more antennas 1216, to execute aspects of method 1500. The method 1400 may employ similar mechanisms as in the networks 100, 200, and 300 and the aspects and actions described with respect to FIGS. 4-11. As illustrated, the method 1500 includes a number of enumerated aspects, but the method 1500 may include additional aspects before, after, and in between the enumerated aspects. In some aspects, one or more of the enumerated aspects may be omitted or performed in a different order.

At action 1510, the method 1500 includes a sidelink UE (e.g., the UE 115 or the UE 1200) configured to receive a sidelink synchronization signal block (S-SSB) in a first S-SSB slot of an S-SSB burst.

At action 1520, the method 1500 includes the sidelink UE configured to communicate, based on the received S-SSB, a sidelink communication in at least one remaining S-SSB slot of the S-SSB burst.

In some aspects, the communicating the sidelink communication includes transmitting, to the another sidelink UE, at least one of sidelink control information (SCI) via a physical sidelink control channel (PSCCH) or sidelink data via a physical sidelink shared channel (PSSCH). In some aspects, the method 1500 further includes performing a listen-before-talk (LBT) procedure after the receiving the S-SSB, wherein the transmitting the at least one of the SCI or the sidelink data is based, at least in part, on the LBT procedure being successful. In some aspects, the S-SSB is a first S-SSB, the method 1500 further includes receiving, from a third sidelink UE, a second S-SSB in a second S-SSB slot of the S-SSB burst, wherein the transmitting is after both the first S-SSB slot and the second S-SSB slot. In some aspects, wherein the communicating the sidelink communication includes receiving, from the another sidelink UE, at least one of sidelink control information (SCI) via a physical sidelink control channel (PSCCH) or sidelink data via a physical sidelink shared channel (PSSCH). In some aspects, the communicating the sidelink communication is based, at least in part, on an indication in a radio resource control (RRC) configuration. In some aspects, the method 1500 further includes performing a synchronization process based on a reference signal received from a global navigation satellite system (GNSS), a reference signal received from a base station (BS), or the S-SSB received from the another sidelink UE.

Further aspects of the present disclosure include the following:

Aspect 1 includes a method of wireless communication performed by a first sidelink user equipment (UE), the method comprising transmitting a sidelink synchronization signal block (S-SSB) in a first S-SSB slot of an S-SSB burst, and communicating a sidelink communication in at least one remaining S-SSB slot of the S-SSB burst.

Aspect 2 includes the method of aspect 1, wherein the communicating the sidelink communication comprises transmitting at least one of sidelink control information (SCI) via a physical sidelink control channel (PSCCH) or sidelink data via a physical sidelink shared channel (PSSCH).

Aspect 3 includes the method of any of aspects 1-2, wherein the communicating the sidelink communication comprises receiving at least one of sidelink control information via a physical sidelink control channel (PSCCH) or sidelink data via a physical sidelink shared channel (PSSCH).

Aspect 4 includes the method of any of aspects 1-3 further comprising transmitting padding data during the first S-SSB slot based on the transmitting the S-SSB being completed before an end of the first S-SSB slot.

Aspect 5 includes the method of any of aspects 1-4 further comprising performing a listen-before-talk (LBT) procedure; and acquiring, based on the LBT procedure being successful, a channel occupancy time (COT), wherein the first S-SSB slot is within the COT.

Aspect 6 includes the method of any of aspects 1-5, wherein the communicating the sidelink communication is based, at least in part, on an indication in a radio resource control (RRC) configuration.

Aspect 7 includes the method of any of aspects 1-6, further comprising receiving the RRC configuration.

Aspect 8 includes the method of any of aspects 1-7, wherein the at least one remaining S-SSB slot is immediately after the first S-SSB slot.

Aspect 9 includes method of wireless communication performed by a sidelink user equipment (UE), the method comprising receiving, from another sidelink UE, a sidelink synchronization signal block (S-SSB) in a first S-SSB slot of an S-SSB burst; and communicating, based on the receiving the S-SSB, a sidelink communication in at least one remaining S-SSB slot of the S-SSB burst.

Aspect 10 includes the method of aspect 9, wherein the communicating the sidelink communication comprises transmitting, to the another sidelink UE, at least one of sidelink control information (SCI) via a physical sidelink control channel (PSCCH) or sidelink data via a physical sidelink shared channel (PSSCH).

Aspect 11 includes the method of any of aspects 9-10 further comprising performing a listen-before-talk (LBT) procedure after the receiving the S-SSB, wherein the transmitting the at least one of the sidelink control information or the sidelink data is based, at least in part, on the LBT procedure being successful.

Aspect 12 includes the method of any of aspects 9-11, wherein the S-SSB is a first S-SSB, the method further comprising receiving, from a third sidelink UE, a second S-SSB in a second S-SSB slot of the S-SSB burst, wherein the transmitting is after both the first S-SSB slot and the second S-SSB slot.

Aspect 13 includes the method of any of aspects 9-12, wherein the communicating the sidelink communication comprises receiving, from the another sidelink UE, at least one of sidelink control information via a physical sidelink control channel (PSCCH) or sidelink data via a physical sidelink shared channel (PSSCH).

Aspect 14 includes the method of any of aspects 9-13, wherein the communicating the sidelink communication is based, at least in part, on an indication in a radio resource control (RRC) configuration.

Aspect 15 includes the method of any of aspects 9-14, further comprising performing a synchronization process based on a reference signal received from a global navigation satellite system (GNSS), a reference signal received from a base station (BS), or the S-SSB received from the another sidelink UE.

Aspect 16 includes a non-transitory computer-readable medium storing one or more instructions for wireless communication, the one or more instructions comprising one or more instructions that, when executed by one or more processors of a first sidelink (UE), cause the first sidelink UE to perform any one of aspects 1-8.

Aspect 17 includes a non-transitory computer-readable medium storing one or more instructions for wireless communication, the one or more instructions comprising one or more instructions that, when executed by one or more processors of a sidelink user equipment (UE), cause the sidelink UE to perform any one of aspects 9-15.

Aspect 18 includes a first sidelink user equipment (UE) comprising one or more means to perform any one or more of aspects 1-8.

Aspect 19 includes a sidelink user equipment (UE) comprising one or more means to perform any one or more of aspects 9-15.

Aspect 20 includes a first sidelink user equipment (UE) comprising a memory, a transceiver, and at least one processor coupled to the memory and the transceiver, wherein the first sidelink UE is configured to perform any one or more of aspects 1-8.

Aspect 21 includes a sidelink user equipment (UE) comprising a memory, a transceiver, and at least one processor coupled to the memory and the transceiver, wherein the sidelink UE is configured to perform any one or more of aspects 9-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a first sidelink user equipment (UE), the method comprising:
transmitting a sidelink synchronization signal block (S-SSB) in a first S-SSB slot of an S-SSB burst; and
communicating a sidelink communication in at least one remaining S-SSB slot of the S-SSB burst.

2. The method of claim 1, wherein the communicating the sidelink communication comprises:
transmitting at least one of sidelink control information (SCI) via a physical sidelink control channel (PSCCH) or sidelink data via a physical sidelink shared channel (PSSCH).

3. The method of claim 1, wherein the communicating the sidelink communication comprises:
receiving at least one of sidelink control information (SCI) via a physical sidelink control channel (PSCCH) or sidelink data via a physical sidelink shared channel (PSSCH).

4. The method of claim 1, further comprising:
transmitting padding data during the first S-SSB slot based on the transmitting the S-SSB being completed before an end of the first S-SSB slot.

5. The method of claim 1, further comprising:
performing a listen-before-talk (LBT) procedure; and
acquiring, based on the LBT procedure being successful, a channel occupancy time (COT), wherein the first S-SSB slot is within the COT.

6. The method of claim 1, wherein the communicating the sidelink communication is based, at least in part, on an indication in a radio resource control (RRC) configuration.

7. The method of claim 6, further comprising:
receiving the RRC configuration.

8. The method of claim 1, wherein the at least one remaining S-SSB slot is immediately after the first S-SSB slot.

9. A method of wireless communication performed by a sidelink user equipment (UE), the method comprising:
receiving, from another sidelink UE, a sidelink synchronization signal block (S-SSB) in a first S-SSB slot of an S-SSB burst; and
communicating, based on the receiving the S-SSB, a sidelink communication in at least one remaining S-SSB slot of the S-SSB burst.

10. The method of claim 9, wherein the communicating the sidelink communication comprises:
transmitting, to the another sidelink UE, at least one of sidelink control information (SCI) via a physical sidelink control channel (PSCCH) or sidelink data via a physical sidelink shared channel (PSSCH).

11. The method of claim 10, further comprising:
performing a listen-before-talk (LBT) procedure after the receiving the S-SSB,
wherein the transmitting the at least one of the SCI or the sidelink data is based, at least in part, on the LBT procedure being successful.

12. The method of claim 10, wherein the S-SSB is a first S-SSB, the method further comprising:
receiving, from a third sidelink UE, a second S-SSB in a second S-SSB slot of the S-SSB burst,
wherein the transmitting is after both the first S-SSB slot and the second S-SSB slot.

13. The method of claim 9, wherein the communicating the sidelink communication comprises:
receiving, from the another sidelink UE, at least one of sidelink control information (SCI) via a physical sidelink control channel (PSCCH) or sidelink data via a physical sidelink shared channel (PSSCH).

14. The method of claim 9, wherein the communicating the sidelink communication is based, at least in part, on an indication in a radio resource control (RRC) configuration.

15. The method of claim 9, further comprising:
performing a synchronization process based on a reference signal received from a global navigation satellite system (GNSS), a reference signal received from a base station (BS), or the S-SSB received from the another sidelink UE.

16. A first sidelink user equipment (UE) comprising:
a memory;
a transceiver; and
at least one processor coupled to the memory and the transceiver, wherein the first sidelink UE is configured to:
transmit a sidelink synchronization signal block (S-SSB) in a first S-SSB slot of an S-SSB burst; and
communicate a sidelink communication in at least one remaining S-SSB slot of the S-SSB burst.

17. The first sidelink UE of claim 16, wherein the first sidelink UE is further configured to communicate the sidelink communication by transmitting at least one of sidelink control information (SCI) via a physical sidelink control channel (PSCCH) or sidelink data via a physical sidelink shared channel (PSSCH).

18. The first sidelink UE of claim 16, wherein the first sidelink UE is further configured to communicate the sidelink communication by receiving at least one of sidelink control information (SCI) via a physical sidelink control channel (PSCCH) or sidelink data via a physical sidelink shared channel (PSSCH).

19. The first sidelink UE of claim 16, wherein the first sidelink UE is further configured to transmit padding data during the first S-SSB slot based on the transmitting the S-SSB being completed before an end of the first S-SSB slot.

20. The first sidelink UE of claim 16, wherein the first sidelink UE is further configured to:
perform a listen-before-talk (LBT) procedure; and
acquire, based on the LBT procedure being successful, a channel occupancy time (COT), wherein the first S-SSB slot is within the COT.

21. The first sidelink UE of claim 16, wherein the first sidelink UE is further configured to communicate the sidelink communication based, at least in part, on an indication in a radio resource control (RRC) configuration.

22. The first sidelink UE of claim 21, wherein the first sidelink UE is further configured to receive the RRC configuration.

23. The first sidelink UE of claim 16, wherein the at least one remaining S-SSB slot is immediately after the first S-SSB slot.

24. A sidelink user equipment (UE) comprising:
a memory;
a transceiver; and
at least one processor coupled to the memory and the transceiver, wherein the sidelink UE is configured to:
receive, from another sidelink UE, a sidelink synchronization signal block (S-SSB) in a first S-SSB slot of an S-SSB burst; and
communicate, based on the receiving the S-SSB, a sidelink communication in at least one remaining S-SSB slot of the S-SSB burst.

25. The sidelink UE of claim 24, wherein the sidelink UE is further configured to communicate the sidelink communication by transmitting, to the another sidelink UE, at least one of sidelink control information (SCI) via a physical sidelink control channel (PSCCH) or sidelink data via a physical sidelink shared channel (PSSCH).

26. The sidelink UE of claim 25, wherein the sidelink UE is further configured to perform a listen-before-talk (LBT) procedure after the receiving the S-SSB, and wherein the transmitting the at least one of the SCI or the sidelink data is based, at least in part, on the LBT procedure being successful.

27. The sidelink UE of claim 25, wherein the S-SSB is a first S-SSB, wherein the sidelink UE is further configured to receive, from a third sidelink UE, a second S-SSB in a second S-SSB slot of the S-SSB burst, and wherein the transmitting is after both the first S-SSB slot and the second S-SSB slot.

28. The sidelink UE of claim 24, wherein the sidelink UE is further configured to communicate the sidelink communication by receiving, from the another sidelink UE, at least one of sidelink control information (SCI) via a physical sidelink control channel (PSCCH) or sidelink data via a physical sidelink shared channel (PSSCH).

29. The sidelink UE of claim 24, wherein the sidelink UE is further configured to communicate the sidelink communication based, at least in part, on an indication in a radio resource control (RRC) configuration.

30. The sidelink UE of claim 24, wherein the sidelink UE is further configured to perform a synchronization process based on a reference signal received from a global navigation satellite system (GNSS), a reference signal received from a base station (BS), or the S-SSB received from the another sidelink UE.
